(19) United States
(12) Patent Application Publication
(10) Pub. No.: US 2023/0330455 A1
(43) Pub. Date: Oct. 19, 2023

(54) RESPIRATOR

(71) Applicant: Takaya Technology Inc., Halifax (CA)

(72) Inventors: Erin MacKean, Halifax (CA); Andrew MacKean, Halifax (CA); Susan Ripley, Halifax (CA); Alistair Ward, Cambridge (GB); James Wooster, Cambridge (GB); Andrew Forbes, Cambridge (GB)

(21) Appl. No.: 18/213,568

(22) Filed: Jun. 23, 2023

Related U.S. Application Data
(63) Continuation-in-part of application No. PCT/CA2021/051877, filed on Dec. 22, 2021.
(60) Provisional application No. 63/176,823, filed on Apr. 19, 2021.
(60) Provisional application No. 63/130,160, filed on Dec. 23, 2020.

(51) Int. Cl. A62B 23/02; A41D 13/11

(52) U.S. Cl. CPC A62B 23/025; A41D 13/1107; A41D 13/1176

(57) ABSTRACT

A respirator for filtering respirated air by covering a nose area to a jaw area of a user is disclosed. The respirator includes a mask body with a front mouth panel and an upper rear nose panel. The mouth panel having a front panel outer portion and a front panel fold portion. The upper nose panel having an upper nose panel fold portion and an upper nose panel free portion. A juncture of the upper nose panel fold portion and the front panel fold portion being a movable fold. The movable fold being upwardly movable between a closed mouth position and an open mouth position, an edge spacing between an upper mask edge and an upper mouth panel edge being greater in the open mouth position than in the closed mouth position.

### CROSS REFERENCE TO RELATED APPLICATIONS

This application is a continuation in part of PCT International Application PCT/CA2021/051877 filed Dec. 22, 2021, which claims the benefit of priority to U.S. Provisional Application No. 63/130,160, filed Dec. 23, 2020, U.S. Provisional Application No. 63/176,823, filed Apr. 19, 2021. The contents of all of these applications are incorporated herein by reference in their entirety.

### FIELD

This application relates to the field of respirators and more particularly, respirators for covering the nose and mouth area of a user for filtration of air.

### INTRODUCTION

The following is not an admission that anything discussed below is part of the prior art or part of the common general knowledge of a person skilled in the art.

Various types of respirators are known, including traditional respirators that cover the nose area and mouth area of a user. However, traditional respirators cause discomfort when worn for extended periods of time, provide an inconsistent connection with the face of the user and lose their connection with the face of the user with movement of the jaw of the user. For example, the inconsistent connection may include poor fit, lack of filtration, and fogging of glasses worn by the user.

### SUMMARY

In accordance with one aspect of this disclosure, a respirator is provided with a rolling fold extending between a front panel and at least one rear panel. An advantage of this design is that the rolling fold allows for relative motion between the front panel and the at least one rear panel caused by movement of the user's jaw. Accordingly, the fit, comfort, and performance of the respirator is improved.

In accordance with this aspect, there is provided a respirator for filtering respirated air by covering a nose area to a jaw area of a user, comprising:
a mask body having:
a front mouth panel having a front panel outer portion extending from an upper mouth panel edge to a lower chin edge and a front panel fold portion extending from the upper mouth panel edge, the front panel fold portion located behind the front panel outer portion; and
an upper nose panel having an upper nose panel fold portion and an upper nose panel free portion,
the upper nose panel fold portion extending from the front panel fold portion and underlying the front mouth panel, and the upper nose panel free portion extending upwardly from the upper nose panel fold portion to an upper mask edge, the upper nose panel free portion located above the front mouth panel,
a juncture of the upper nose panel fold portion and the front panel fold portion being a movable fold;
the movable fold being upwardly movable between a closed mouth position and an open mouth position, an edge spacing between the upper mask edge and the upper mouth panel edge being greater in the open mouth position than in the closed mouth position.

In any embodiment, at a horizontal center of the mask body,
the front panel outer portion may have a front panel outer portion height,
the nose panel free portion may have a nose panel free portion height,
the front panel fold portion may have a front panel fold portion height, and
the upper nose panel fold portion may have an upper nose fold portion height, and
when the respirator is in the closed mouth position, a fold height ratio between a) a combined interior height of the front panel fold portion height and the upper nose fold portion height and b) a combined exterior height of the mouth outer portion height and the nose panel free portion height, may be in the range of about 0.4 to about 0.65.

In any embodiment, the mouth outer portion may have a mouth outer portion surface area,
the nose panel free portion may have a nose panel free portion surface area,
the front panel fold portion may have a front panel fold portion surface area,
the upper nose panel fold portion may have an upper nose fold portion surface area, and an interior fold surface area may be formed by the front panel fold portion surface area and the upper nose fold portion surface area,
an exterior mask body surface area may be formed by the mouth outer portion surface area and the nose panel free portion surface area, and
when the respirator is in the closed mouth position a fold surface area ratio between the interior fold surface area and the exterior mask body surface area may be in the range of about 0.4 to about 0.65.

In any embodiment, the front mouth panel may further comprise laterally spaced apart first and second rear edges, each rear edge having an upper portion, a lower portion, and a tab projecting rearwardly of the upper and lower portions.

In any embodiment, the respirator may further comprise a perimeter edge region around the mask body for contacting the skin of the user, the perimeter edge region may have a facial attachment seal for sealingly connecting the respirator to the skin of the user, and the tabs may be located rearward of the facial attachment seal.

In any embodiment, the respirator may further comprise a first strap attached to the mask body above the tab of each rear edge and a second strap attached to the mask body below the tab of each rear edge.

In any embodiment, the front mouth panel may comprise at least three layers including an interior layer with a higher stiffness than at least two other layers that increases the stiffness of the front mouth panel by greater than about 1000%.

In any embodiment, the front mouth panel may comprise a mouth portion and a chin portion and the interior layer with higher stiffness may be positioned exclusively in the mouth portion.

In any embodiment, the front panel fold portion may be rigidly attached to the front panel outer portion at a location below the upper mouth panel edge to constrain the front fold portion from flattening.

In any embodiment, the movable fold may be a rounded fold.

In any embodiment, a location of the rounded fold may move when the mask body moves between the open mouth position and the closed mouth position.

In any embodiment, the respirator may further comprise a perimeter edge region around the mask body for contacting the skin of the user, the perimeter edge region may have a facial attachment seal for sealingly connecting the respirator to the skin of the user.

In any embodiment, the facial attachment seal may have a contour layer and an adhesive layer.

In any embodiment, the contour layer may comprise at least one of an open cell foam and a closed cell foam.

In any embodiment, the adhesive layer may comprise a pressure sensitive adhesive.

In any embodiment, the pressure sensitive adhesive may be a biocompatible adhesive.

In any embodiment, the mask body may further comprise a desiccant.

In any embodiment, the front mouth panel and the upper nose panel may be integrally formed.

In accordance with another aspect, there is provided a respirator for filtering respirated air by covering a nose area to a jaw area of a user, the respirator comprising:
a mask body having:
a front mouth panel having a front panel outer portion extending from an upper mouth panel edge to a lower chin edge and a front panel fold portion extending from the upper mouth panel edge, the front panel fold portion located behind the front panel outer portion; and
an upper nose panel having an upper nose panel fold portion and an upper nose panel free portion,
the upper nose panel fold portion extending from the front panel fold portion and underlying the front mouth panel, and the upper nose panel free portion extending upwardly from the upper nose panel fold portion to an upper mask edge, the upper nose panel free portion located above the front mouth panel,
a juncture of the upper nose panel fold portion and the front panel fold portion being a movable fold;
the movable fold being upwardly movable between a closed mouth position and an open mouth position,
wherein the lower chin edge is mechanically linked to the upper mouth panel edge by a support member such that movement of the lower chin edge causes movement of the upper mouth panel edge, and
wherein the upper mouth panel edge is mechanically decoupled from the upper mask edge by the movable fold such that the front mouth panel is independently movable from the upper nose panel.

In any embodiment, an edge spacing between the upper mask edge and the upper mouth panel edge may be greater in the open mouth position than in the closed mouth position.

In any embodiment, the front panel fold portion and the upper nose panel fold portion may be attached to the front mouth panel proximate a rear edge of the front mouth panel by a first end seam and a second end seam and each of the first end seam and the second end seam may constrain the front panel fold portion and the upper nose panel fold portion from movement proximate the first end seam and the second end seam.

In any embodiment, the support member may be shaped to support a convex shape of the front mouth panel such that the front mouth panel may be spaced apart from a mouth of the user when worn by the user.

In any embodiment, the front mouth panel may comprise a spine extending from proximate the upper mouth panel edge to proximate the lower chin edge and the spine may be attached to at least a portion of the support member.

In any embodiment, the respirator may further comprise an edge forming a perimeter of the mask body for contacting the skin of the user, the perimeter may have a facial attachment seal for sealingly connecting the respirator to the skin of the user.

In any embodiment, when the movable fold moves between the open mouth position and the closed mouth position the facial attachment seal may maintain contact with the skin of the user.

In any embodiment, the facial attachment seal may have a contour layer and an adhesive layer.

In any embodiment, the contour layer may comprise at least one of an open cell foam, a closed cell foam, and a hydrocolloid.

In any embodiment, the adhesive layer may comprise a pressure sensitive adhesive.

In any embodiment, the pressure sensitive adhesive may be biocompatible.

In any embodiment, the front mouth panel and the upper nose panel may be integrally formed.

In any embodiment, the front mouth panel may further comprise laterally spaced apart first and second rear edges, each rear edge may have an upper portion, a lower portion, and a tab projecting rearwardly of the upper and lower portions.

In any embodiment, the respirator may further comprise a perimeter edge region around the mask body for contacting the skin of the user, the perimeter edge region may have a facial attachment seal for sealingly connecting the respirator to the skin of the user, and the tabs may be located rearward of the facial attachment seal.

In accordance with this aspect, there is provided a respirator for filtering respirated air by covering the nose area to the jaw area of a user, comprising:
a mask body having:
a front panel with a first end defining an upper edge portion and a second end defining a lower edge portion, the second end located opposite to the first end;
an upper rear panel;
a lower panel;
the upper rear panel being coupled to the first end of the front panel along the upper edge portion and projecting rearwardly therefrom toward the user's nose area, and
the lower panel being proximate to the second end of the front panel and projecting rearwardly therefrom toward the user's jaw area;
wherein at least one of the upper rear panel and the lower panel comprises a fold, optionally in this embodiment and the others described below, a permanent rolling fold, extending between the front panel and the at least one of the upper rear panel and the lower panel, the rolling fold for allowing relative motion between the front panel and the at least one of the upper rear panel and the lower panel caused by movement of the user's jaw.

In any embodiment, the rolling fold may be maintained throughout the range of user jaw movement.

In any embodiment, the rolling fold may be adjustable between a closed length and an open length.

In any embodiment, the open length may be less than the closed length and the open length may be greater than zero.

In any embodiment, the rolling fold may be constrained from flattening by an excess of material in the rolling fold that remains folded at a maximum open jaw position during user jaw movement.

In any embodiment, the front panel may comprise a support member having upper edge support member, a lower edge support member, a first side edge support member and a second side edge support member, the first and second side edge support members extending between the upper edge support member and the lower edge support member.

In any embodiment, the support member may provide resilience to the rolling fold such that the rolling fold is biased towards the closed length.

In any embodiment, the rolling fold may be formed along the at least one of the upper and lower edge portions, and the rolling fold may comprises:
a front panel fold portion;
a rear panel fold portion;
the front and rear panel fold portions coupled by a rounded fold therebetween to form the rolling fold.

In any embodiment, the front panel fold portion may form an acute angle with the front panel, the front panel fold portion projecting inwardly and forming the rounded fold with the rear panel fold portion, the rounded fold located at a turn position.

In any embodiment, the turn position may comprise a U-shaped turn portion.

In any embodiment, the turn position may move in response to user jaw movement.

In any embodiment, the respirator may further comprise an edge around the perimeter of the mask body for contacting the skin of the user, the perimeter may have a facial attachment seal for sealingly connecting the respirator to the skin of the user.

In any embodiment, when the rolling fold moves between the closed length and the open length the facial attachment seal may maintain contact with the skin of the user.

In any embodiment, the perimeter may be shaped to minimize contact of the perimeter with the muscles of mastication and muscles of communication of the user.

In any embodiment, the facial attachment seal may have a contour layer and an adhesive layer.

In any embodiment, the contour layer may comprise an open cell foam.

In any embodiment, the adhesive layer may comprise a pressure sensitive adhesive.

In any embodiment, the pressure sensitive adhesive may be medical silicone tape.

In any embodiment, the front panel, the upper rear panel, and the lower panel may each extend between temporomandibular joints of the user.

In any embodiment, the respirator may further comprise at least one desiccant for removing moisture from an interior of the respirator when worn by the user.

In any embodiment, the front panel, the upper rear panel, and the lower panel may consist of a single sheet of material.

In any embodiment, the rolling fold may be a first rolling fold extending between the front panel and the lower panel and a second rolling fold may extend between the front panel and the upper rear panel.

In any embodiment, the lower panel may be a lower rear panel.

In any embodiment, the lower rear panel may be coupled to the second end of the front panel along the lower edge portion and may project rearwardly therefrom toward the user's jaw area.

In any embodiment, the front panel and the lower panel may be formed of a single continuous sheet having an upper panel surface and a lower panel surface.

In accordance with another aspect herein, there is provided a respirator for filtering respirated air by covering a nose area to a jaw area of a user, the respirator comprising:
a mask body having:
   a front panel with a first end defining an upper edge portion and a second end defining a lower edge portion, the second end located opposite to the first end; and
   an upper rear panel being coupled to the first end of the front panel along the upper edge portion and projecting rearwardly therefrom toward the nose area of the user,
wherein the upper rear panel comprises a connector or a fold (connector or fold optionally made of mask filter material, for example, a fabric with suitable filter properties), optionally a rolling fold, extending between the front panel and the upper rear panel, the connector, fold or rolling fold extending between a first end and a second end with a middle portion therebetween,
wherein the connector, fold or rolling fold allows for relative motion between the front panel and the upper rear panel caused by the movement of the jaw such that the connector, fold or rolling fold is moveable between a closed position when the user's jaw is closed and an open position when the user's jaw is opened,
wherein the lower edge portion is mechanically linked to the upper edge portion by a support member such that movement of the lower edge portion causes movement of the upper edge portion, and
wherein the upper edge portion of the front panel is mechanically decoupled from an upper rear edge of the upper rear panel by excess material in the connector, fold or rolling fold such that the front panel is independently moveable from the upper rear panel.

In any embodiment, wherein the excess material of the rolling fold may be adjustable between an open length when the rolling fold is in the open position and a closed length when the rolling fold is in the closed position and the open length may be less than the closed length.

In any embodiment, the rolling fold may have a first end seam and a second end seam and each of the first end seam and the second end seam may constrain the rolling fold from movement proximate the first end seam and the second end seam.

In any embodiment the support member may be shaped to support a convex shape of the front panel such that the front panel is spaced apart from a mouth of the user.

In any embodiment the front panel may comprise a spine extending from proximate the upper edge portion to proximate the lower edge portion and the spine may be formed by at least a portion of the support member.

In any embodiment the spine may have a spine height that is normal to the front panel and the spine height may be tapered proximate the upper edge portion.

In any embodiment, the respirator may further comprise an edge forming a perimeter of the mask body for contacting the skin of the user, the perimeter having a facial attachment seal for sealingly connecting the respirator to the skin of the user.

In any embodiment, when the rolling fold moves between the open position and the closed position the facial attachment seal may maintain contact with the skin of the user.

In any embodiment the perimeter may be shaped to minimize contact of the perimeter with muscles of mastication and muscles of communication of the user.

In any embodiment, the facial attachment seal may have a contour layer and an adhesive layer.

In any embodiment the contour layer may comprise at least one of an open cell foam, a closed cell foam, and a hydrocolloid.

In any embodiment the adhesive layer may comprise a pressure sensitive adhesive.

In any embodiment, the pressure sensitive adhesive may be biocompatible.

In any embodiment, the first end of the rolling fold may be positioned proximate a first temporomandibular joint of the user and the second end of the rolling fold may be positioned proximate a second temporomandibular joint of the user.

In any embodiment, the front panel may comprise a single continuous sheet of material that extends from the upper edge to the lower edge.

In any embodiment, the front panel may comprise a front panel length between the upper edge and the lower edge and the support member may extend along a substantial portion of the front panel length.

These and other aspects and features of various embodiments will be described in greater detail below.

### BRIEF DESCRIPTION OF THE DRAWINGS

For a better understanding of the described embodiments and to show more clearly how they may be carried into effect, reference will now be made, by way of example, to the accompanying drawings in which:

FIG. 1 is a front perspective view of a respirator in accordance with an embodiment;

FIG. 2 is a front view of the respirator of FIG. 1;

FIG. 3 is a side view of the respirator of FIG. 1;

FIG. 4 is a rear view of the respirator of FIG. 1;

FIG. 5 is a top view of the respirator of FIG. 1;

FIG. 6 is a bottom view of the respirator of FIG. 1;

FIG. 7 is a cross-sectional side view of the respirator of FIG. 1, taken along the line A-A in FIG. 2;

FIG. 8 is a partial cross-sectional view of the respirator of FIG. 1, taken along the line A-A in FIG. 2;

FIG. 9 is a front view of a user with an outline of the respirator of FIG. 1 for illustrating anatomical positioning;

FIG. 10 is an exploded perspective view of the respirator of FIG. 1;

FIG. 11 is an exploded perspective view of the respirator of FIG. 1;

FIG. 12 is a front perspective view of a support member of the respirator of FIG. 1;

FIG. 13 is an exploded perspective view of another respirator in accordance with an exemplary embodiment;

FIG. 14A is a front perspective view of a respirator in a closed position in accordance with another embodiment

FIG. 14B is a front perspective view of the respirator of FIG. 14A in an open position;

FIG. 15A is a side perspective view of the respirator of FIG. 14A in the closed position;

FIG. 15B is a side perspective view of the respirator of FIG. 14A in the open position;

FIG. 16A is a rear perspective view of the respirator of FIG. 14A in the closed position;

FIG. 16B is a rear perspective view of the respirator of FIG. 14A in the open position;

FIG. 17A is a side perspective view of the respirator of FIG. 14A in the closed position;

FIG. 17B is a side perspective view of the respirator of FIG. 14A in the open position;

FIG. 18A is a rear view of the respirator of FIG. 14A in a first step of assembly;

FIG. 18B is a rear view of the respirator of FIG. 14A in a second step of assembly;

FIG. 19A is a rear view of the respirator of FIG. 14A in a third step of assembly;

FIG. 19B is a rear view of the respirator of FIG. 14A in a fourth step of assembly;

FIG. 20A is a rear view of a disassembled prior art respirator;

FIG. 20B is a rear view of the respirator of FIG. 14A in the first step of assembly;

FIG. 21A is a front perspective view of a respirator in accordance with another embodiment;

FIG. 21B is a front view of the respirator of FIG. 21A;

FIG. 22A is a side view of the respirator of FIG. 21A;

FIG. 22B is a rear view of the respirator of FIG. 21A;

FIG. 23A is a top view of the respirator of FIG. 21A;

FIG. 23B is a bottom view of the respirator of FIG. 21A;

FIG. 24A is a cross-sectional view of the respirator of FIG. 21A, taken along the line B-B in FIG. 21B, with the respirator in a closed position;

FIG. 24B is a cross-sectional view of the respirator of FIG. 21A, taken along the line B-B in FIG. 21B, with the respirator in an open position;

FIG. 25A is a close-up view of FIG. 24A;

FIG. 25B is a close-up view of FIG. 24B;

FIG. 26 is a partial exploded view of the respirator of FIG. 21A;

FIG. 27 is an exploded view of the respirator of FIG. 21A;

FIGS. 28A-E are illustrated views of a rolling fold of the respirator of FIG. 21A in various positions;

FIG. 28F is a cross-sectional view of the respirator of FIG. 21A, when worn by a user, with the respirator in the closed position;

FIG. 28G is a cross-sectional view of the respirator of FIG. 21A, when worn by a user, with the respirator in the open position;

FIG. 29A is a sectional view of the respirator of FIG. 21A, showing a facial adhesive seal;

FIG. 29B is an exploded view of an unassembled respirator in accordance with another embodiment herein;

FIGS. 30A-30D illustrate a respirator in accordance with another embodiment herein, in various stages of assembly;

FIG. 31A is a front view of a respirator in accordance with another embodiment herein, with the respirator in a closed position;

FIG. 31B is a front view of the respirator of FIG. 31A in an open position;

FIG. 31C is a side view of the respirator of FIG. 31A;

FIG. 31D is a side view of the respirator of FIG. 31B;

FIG. 32A is a rear view of the respirator of FIG. 31A;

FIG. 32B is a rear view of the respirator of FIG. 31B;

FIG. 32C is a top perspective view of the respirator of FIG. 31A;

FIG. 32D is a top perspective view of the respirator of FIG. 31B,

FIG. 33 is a front view of a respirator in accordance with another embodiment herein, with the respirator in a closed position;

FIG. 34A is a front view of the respirator of FIG. 33;

FIG. 34B is a rear view of the respirator of FIG. 33;

FIG. 35 is a front perspective view of the respirator of FIG. 33 in an open position;

FIG. 36A is a side view of the respirator of FIG. 33;

FIG. 36B is a side view of the respirator of FIG. 35;

FIG. 37A is a cross-sectional side view of the respirator of FIG. 33;

FIG. 37B is a cross-sectional side view of the respirator of FIG. 35;

FIG. 38A is an enlarged view of the fold of FIG. 37A; and

FIG. 38B is an enlarged view of the fold of FIG. 37B.

The drawings included herewith are for illustrating various examples of articles, methods, and apparatuses of the teaching of the present specification and are not intended to limit the scope of what is taught in any way.

### DESCRIPTION OF EXAMPLE EMBODIMENTS

Various apparatuses, methods and compositions are described below to provide an example of an embodiment of each claimed invention. No embodiment described below limits any claimed invention and any claimed invention may cover apparatuses and methods that differ from those described below. The claimed inventions are not limited to apparatuses, methods and compositions having all of the features of any one apparatus, method or composition described below or to features common to multiple or all of the apparatuses, methods or compositions described below. It is possible that an apparatus, method or composition described below is not an embodiment of any claimed invention. Any invention disclosed in an apparatus, method or composition described below that is not claimed in this document may be the subject matter of another protective instrument, for example, a continuing patent application, and the applicant(s), inventor(s) and/or owner(s) do not intend to abandon, disclaim, or dedicate to the public any such invention by its disclosure in this document.

The terms “an embodiment,” “embodiment,” “embodiments,” “the embodiment,” “the embodiments,” “one or more embodiments,” “some embodiments,” and “one embodiment” mean “one or more (but not all) embodiments of the present invention(s),” unless expressly specified otherwise.

The terms “including,” “comprising” and variations thereof mean “including but not limited to,” unless expressly specified otherwise. A listing of items does not imply that any or all of the items are mutually exclusive, unless expressly specified otherwise. The terms “a,” “an” and “the” mean “one or more,” unless expressly specified otherwise.

As used herein and in the claims, two or more parts are said to be “coupled”, “connected”, “attached”, or “fastened” where the parts are joined or operate together either directly or indirectly (i.e., through one or more intermediate parts), so long as a link occurs. As used herein and in the claims, two or more parts are said to be “directly coupled”, “directly connected”, “directly attached”, or “directly fastened” where the parts are connected in physical contact with each other. None of the terms “coupled”, “connected”, “attached”, and “fastened” distinguish the manner in which two or more parts are joined together.

Furthermore, it will be appreciated that for simplicity and clarity of illustration, where considered appropriate, reference numerals may be repeated among the FIGS. to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures, and components have not been described in detail so as not to obscure the example embodiments described herein. Also, the description is not to be considered as limiting the scope of the example embodiments described herein.

As used herein, the wording “and/or” is intended to represent an inclusive—or. That is, “X and/or Y” is intended to mean X or Y or both, for example. As a further example, “X, Y, and/or Z” is intended to mean X or Y or Z or any combination thereof.

As used herein and in the claims, two elements are said to be “parallel” where those elements are parallel and spaced apart, or where those elements are collinear.

### General Description of a Respirator

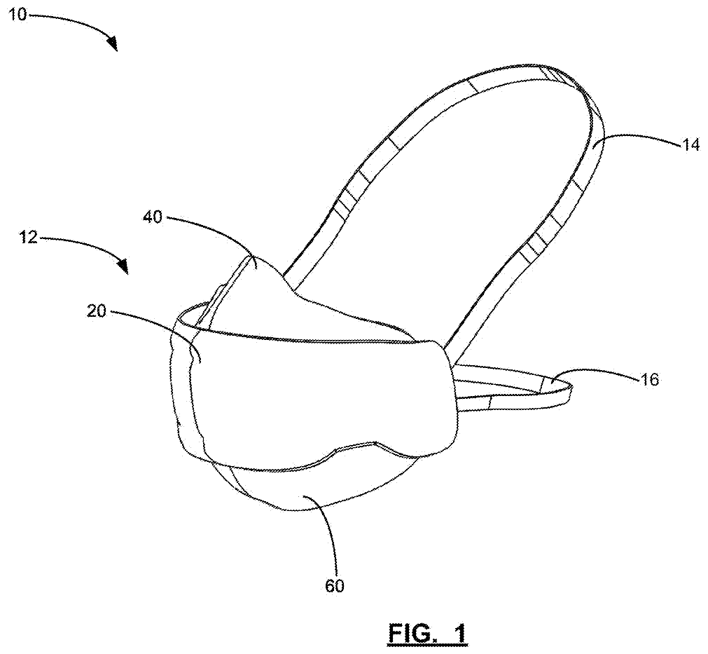

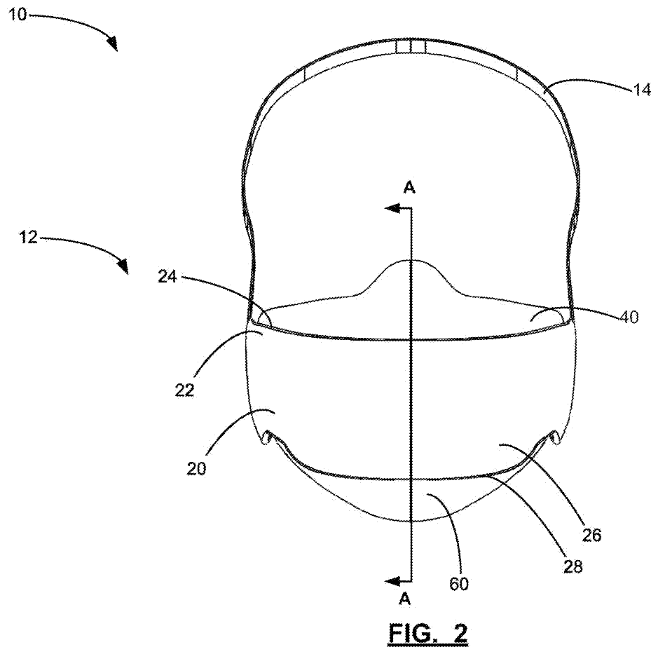

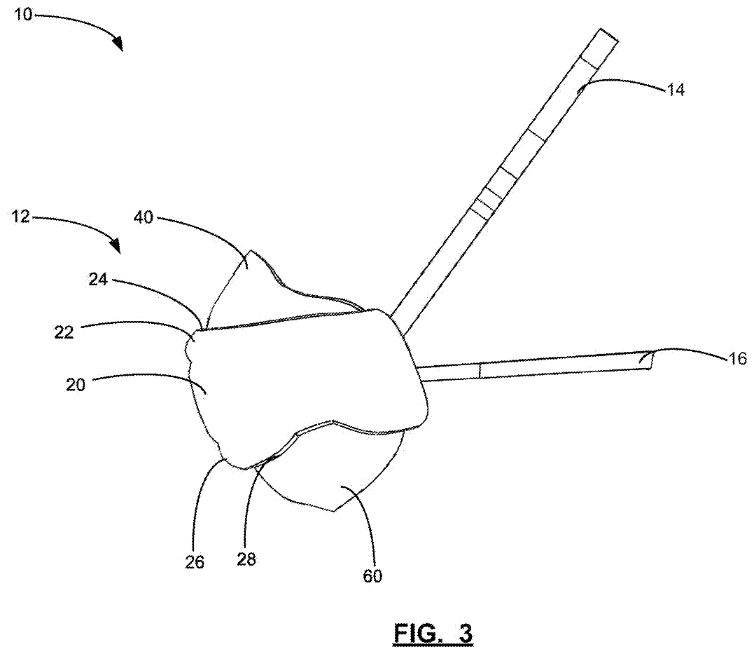

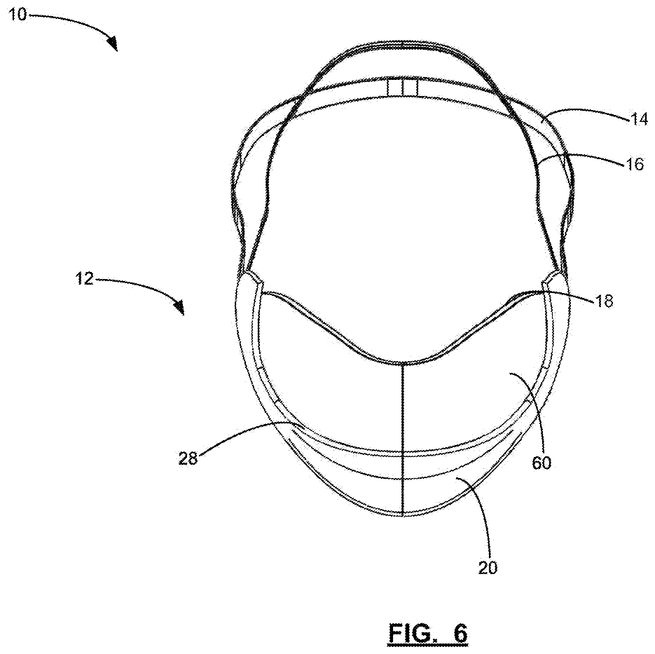

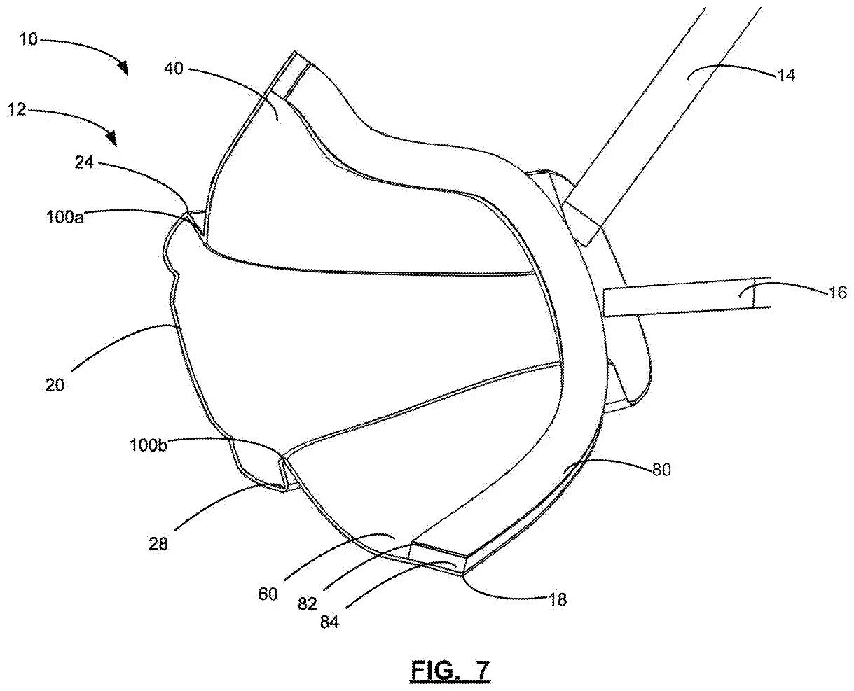

Referring to FIGS. 1-13, an exemplary embodiment of a respirator is shown generally as 10. The following is a general discussion of respirator 10, which provides a basis for understanding several of the features that are discussed herein. As discussed subsequently, each of the features may be used individually or in any particular combination or sub-combination in this or in other embodiments disclosed herein.

Referring to FIG. 1, shown therein is an exemplary embodiment of a respirator 10 having a mask body 12. The respirator 10 is used for filtering respirated air by covering a nose area 210 to a jaw area 220 of a user 200, as illustrated in FIG. 9. The mask body 12 has a front panel 20, an upper rear panel 40, and a lower rear panel 60. In some embodiments, the mask body 12 may have the front panel 20, also referred to as the front mouth panel, and the upper rear panel 40, also referred to as the upper nose panel, and no lower rear panel 60.

The front panel 20 has a first end 22 defining an upper edge portion 24 (also referred to as an upper mouth panel edge) and a second end 26 defining a lower edge portion 28 (also referred to as a lower chin edge). As shown, the second end 26 is located opposite to the first end 22. The front panel has a front panel outer portion 21 that extends from the upper mouth panel edge 24 to the lower chin edge 28.

The upper rear panel 40 is coupled to the first end 22 of the front panel 20 along the upper edge portion 24. The upper rear panel 40 projects rearwardly from the front panel 20 toward the user's nose area 210. The lower rear panel 60 is optionally coupled to the second end 26 of the front panel 20 along the lower edge portion 28. The lower rear panel 60 projects rearwardly from the front panel 20 toward the user's jaw area 220. The upper rear panel 40 and lower rear panel 60 provide a region for contacting the face of a user. As shown, the mask body 12 has an edge 18 forming a perimeter for connecting the respirator 10 to the skin of the user 200.

Optionally, as exemplified, the respirator 10 may have a first strap 14 and a second strap 16. The first strap 14 may be used to secure the respirator 10 along the top of a user's head, while the second strap 16 may be used to secure the respirator 10 along the back of a user's neck. It will be appreciated that there may be any number of straps and that the straps may be positioned anywhere on the user 200 to assist with securing the respirator 10 to the face of the user 200. For example, the straps 14, 16 may help maintain contact between the edge 18 around the perimeter of the mask body 12 and the skin of the user. The straps 14, 16 may be made of any material that is at least partially elastic. For example, the straps 14, 16 may be made of rubber. In some embodiments, the respirator 10 may include ear loops. For example, the respirator 10 may have a first ear loop for attaching to a first ear of the user 200 and a second ear loop for attaching to a second ear of the user 200.

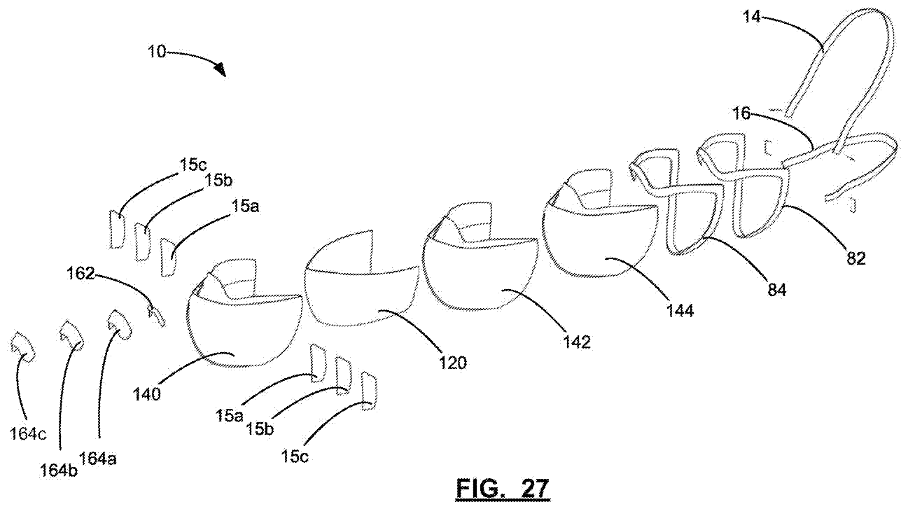

In some embodiments, the mask body 12 may include a pair of strap attachment members 15, as exemplified in FIG. 22B, the strap attachment members 15 may be a piece of fabric that is welded to the front panel 20. As shown in FIG. 27, the strap attachment members may be made of three layers. The three layers may be a spunbond layer 15a, a meltblown layer 15b, and a second spunbond layer 15c.

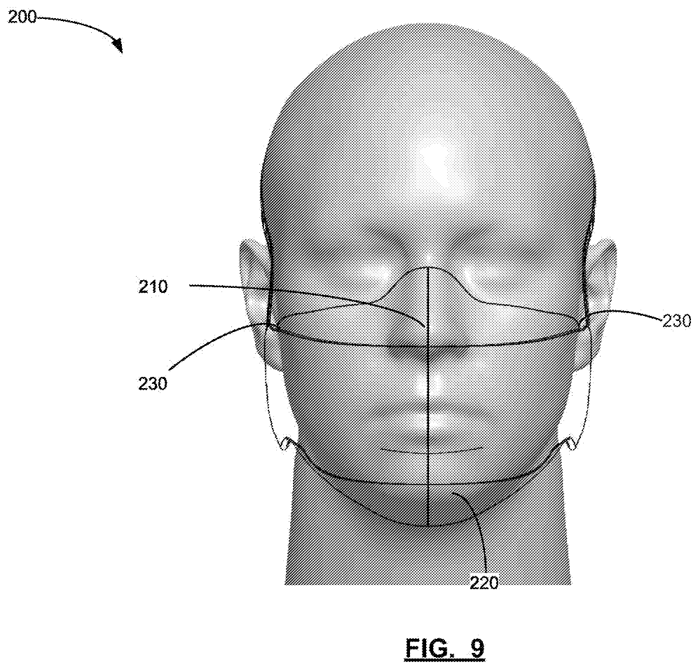

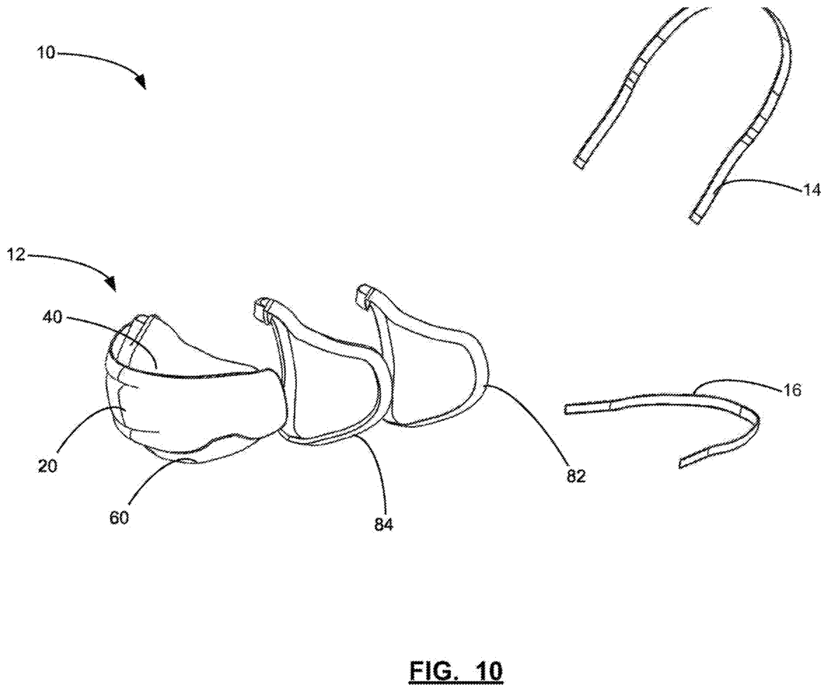

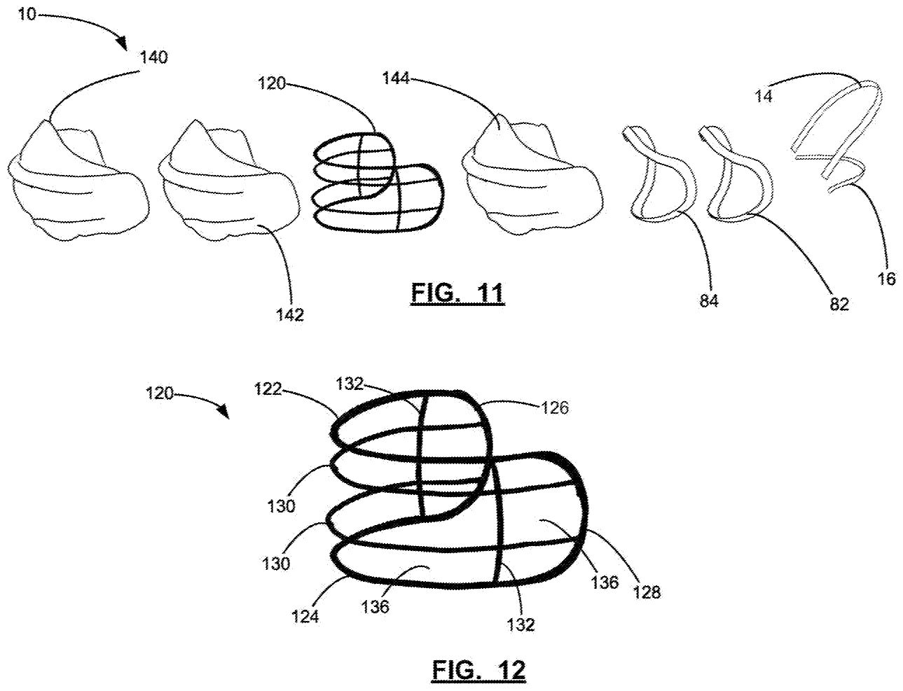

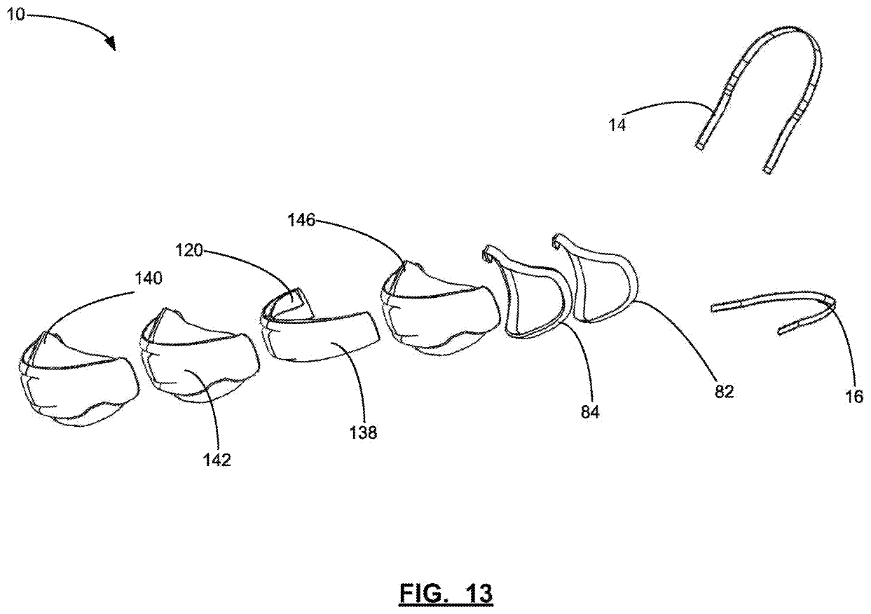

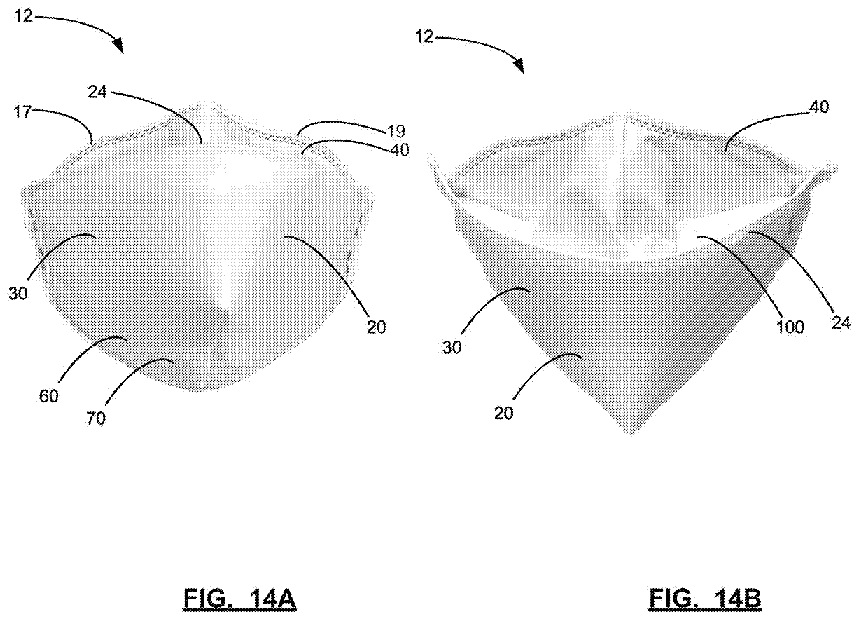

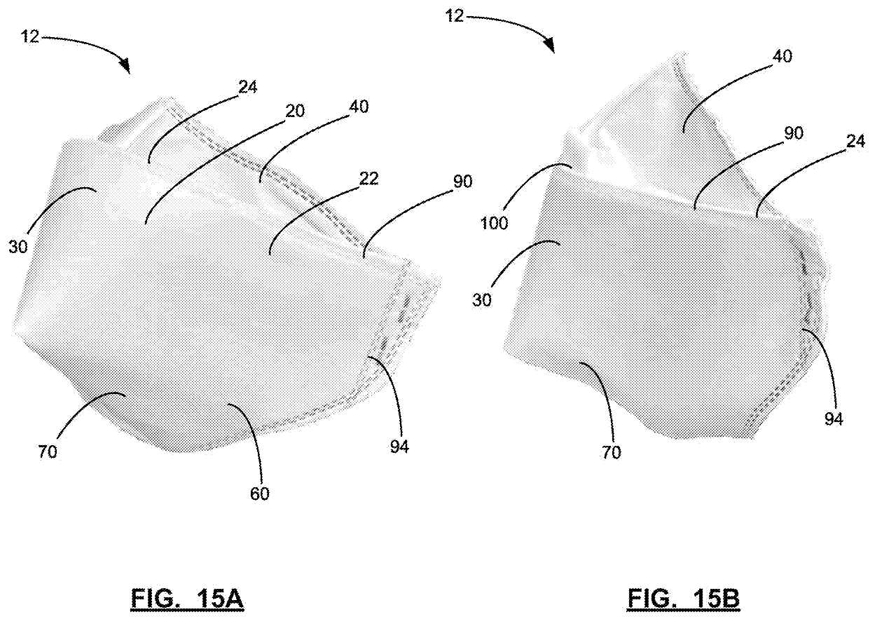

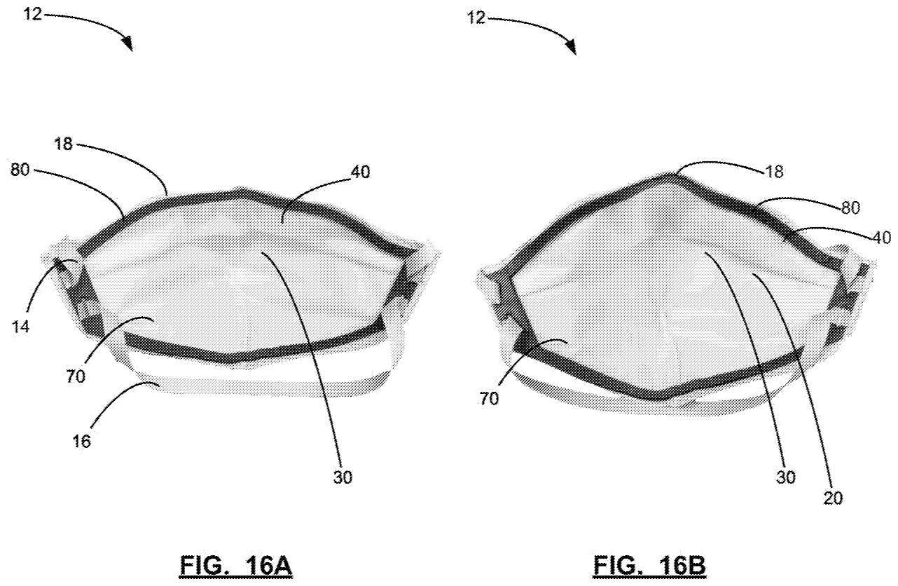

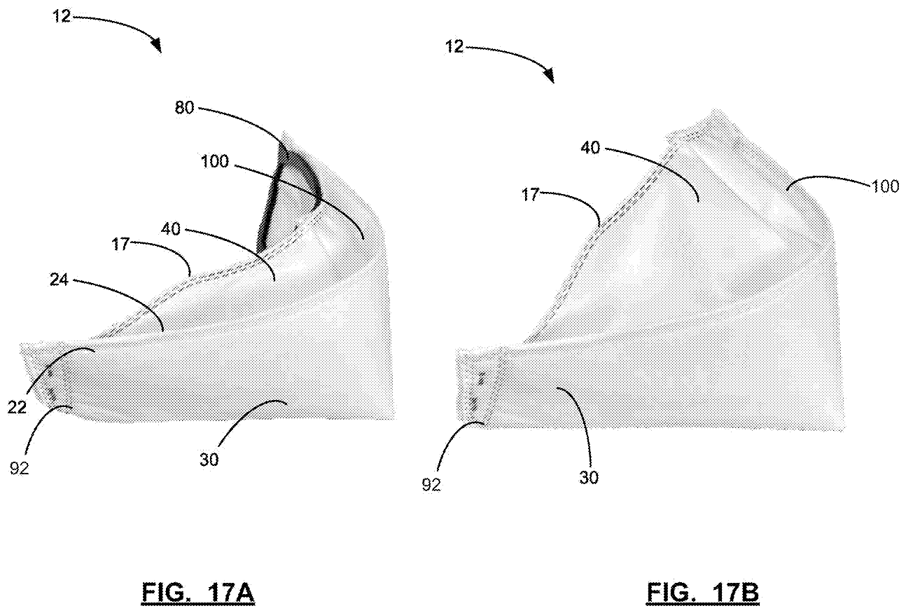

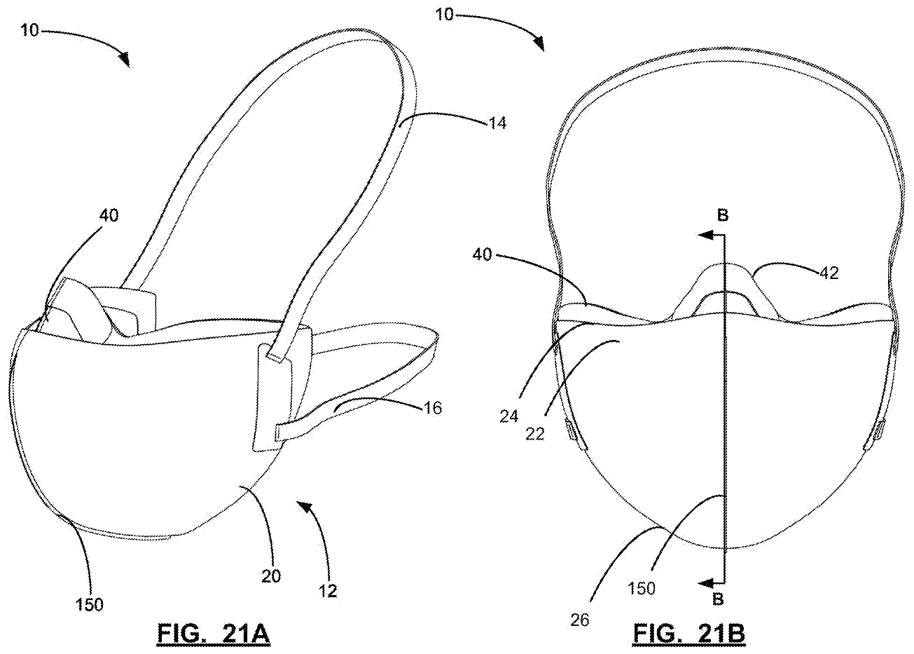

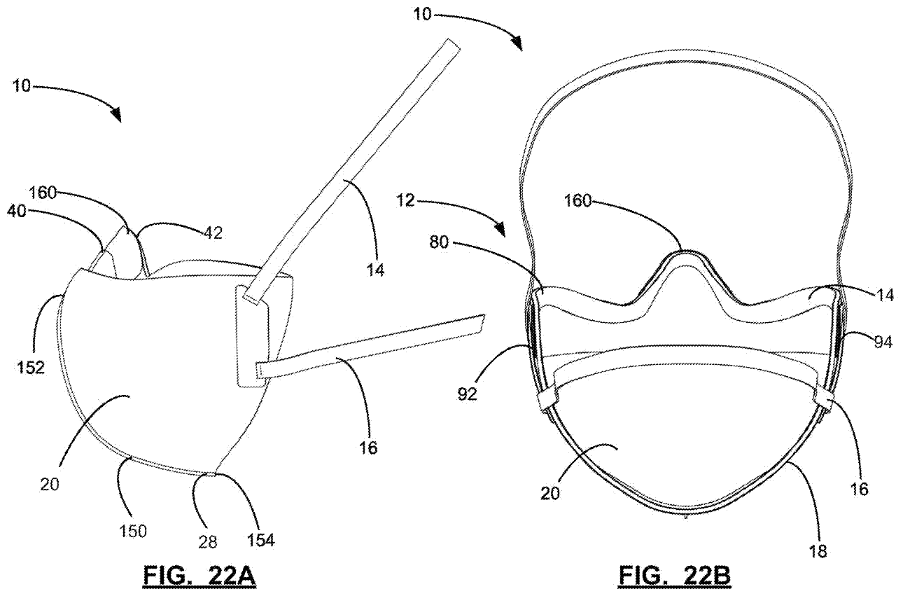

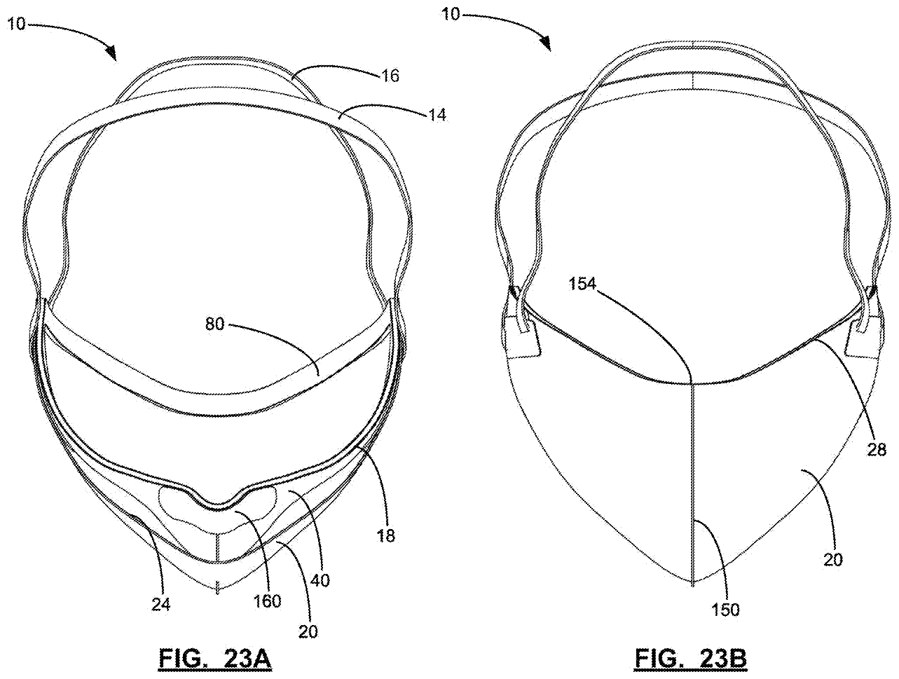

In some embodiments, as exemplified in FIGS. 14A-19B and 21-28, the lower rear panel 60 may be continuous with the front panel 20 and may be referred to as the lower panel 60 or the front mouth panel. As shown, the front panel 20 has an upper panel surface 30 and a lower panel surface 70.

Movable and/or Rolling Fold

In accordance with this aspect, which may be used by itself or in combination with one or more other aspects, the mask body 12 has at least one fold, typically a movable fold (also referred to as a rolling fold) 100. The fold (rolling fold 100) allows for relative motion between the front panel 20 and at least one rear panel 40 and/or 60 caused by movement of the user's jaw 220. An advantage of this aspect is that the user may move their jaw 220 while limiting the effect on the connection between the mask body 12 and the face of the user, thereby improving the efficacy of the respirator 10. For example, providing a more consistent connection with the face of the user may reduce the amount of respiration that leaks out through the edges of the mask, and may reduce the amount of contaminates that enter through the edges of the mask. In both cases, the safety of the user and others is improved.

In other words, the rolling fold 100 may enable mechanical decoupling between the front panel 20 and one or both of the rear panel 40 and rear panel 60. The mechanical decoupling between the front and rear panels may insulate the nose region of the respirator 10 from motion of the jaw of the user, thereby providing for a more consistent fit during movement of the user's mouth. The fold is a connector that optionally extends and contracts to permit the mechanical decoupling.

In accordance with this aspect, as exemplified in FIGS. 1-13, the mask body 12 may have a plurality of rolling folds 100. As shown, the mask body 12 has an upper rolling fold 100a and a lower rolling fold 100b. The upper rolling fold 100a extends between the front panel 20 and the upper rear panel 40. Similarly, the lower rolling fold 100b extends between the front panel 20 and the lower rear panel 60.

The one or more rolling folds 100 allow for relative motion between the front panel 20 and the respective rear panel 40 and/or 60. For example, if a user moves their jaw from a closed position to an open position, the rolling fold 100 adjust to compensate for the movement, thereby maintaining the fit of the mask body 12 against the face of the user.

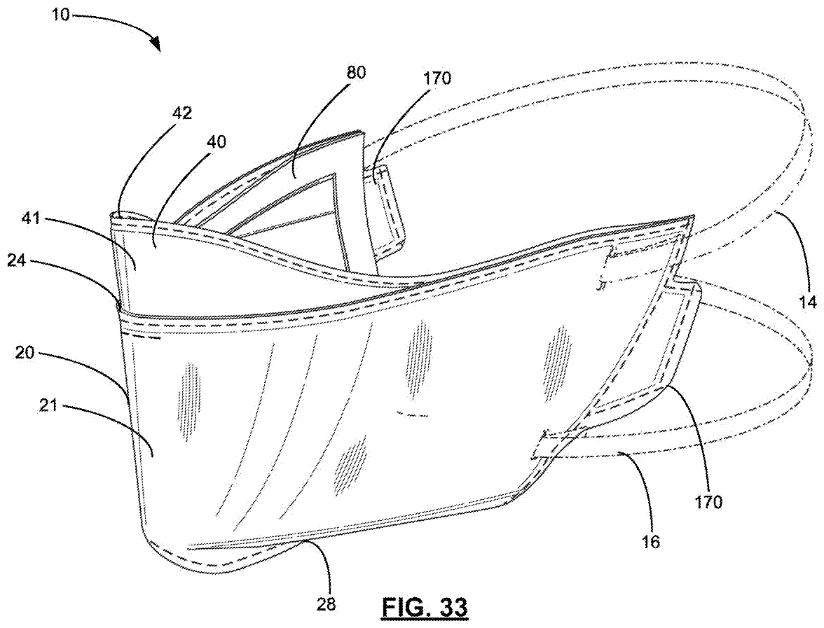

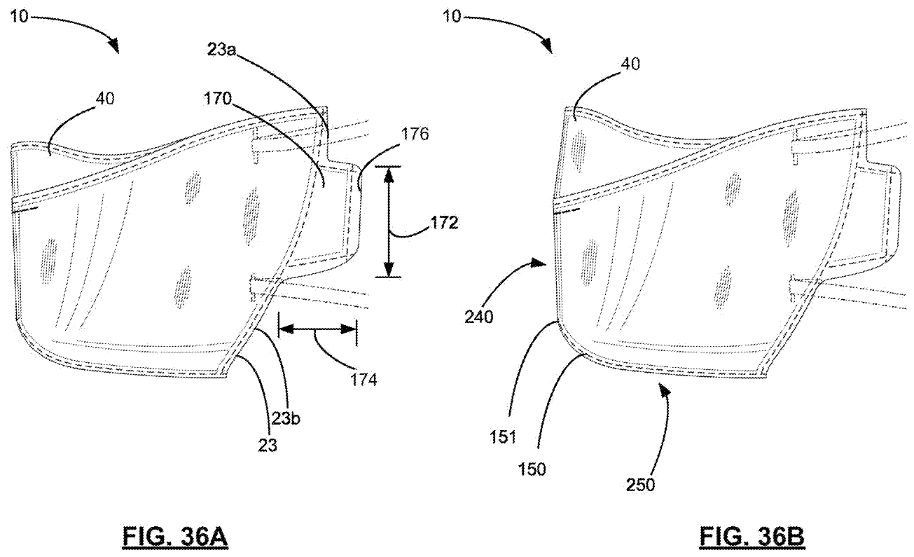

The moveable fold 100 may be movable between a closed mouth position (e.g., FIGS. 33 and 36A) and an open mouth position (e.g., FIGS. 35 and 36B). As exemplified in FIGS. 36A-38B, an edge spacing 180 between the upper mask edge 42 and the upper mouth panel edge 24 may be greater in the open mouth position than in the closed mouth position. In other words, while the rear panel 40 (also referred to as upper nose panel 40) maintains its position, the front panel 20 (also referred to as the front mouth panel 40) may change position with the movement of the user's jaw, thereby increasing and decreasing the edge spacing 180 between the upper mouth panel edge 24 and the upper mask edge 42. It will be appreciated that, in some embodiments, the mask body 12 may have a fold such as a single movable and/or rolling fold 100. For example, referring to FIGS. 14-28 and 31A-38B, the mask body 12 has a single fold 100. The movable and/or rolling fold 100 extends between the upper panel surface 30 of the front panel 20 and the upper rear panel 40.

The rolling fold 100 may be maintained across a wide range of movement of the jaw of the user. In other words, the rolling fold 100 may be at least partially folded along its corresponding panel edge portion and is capable of moving and/or rolling with the motion of the jaw of the user. For example, the rolling fold 100 may be at least partially maintained throughout the full range of user jaw movement.

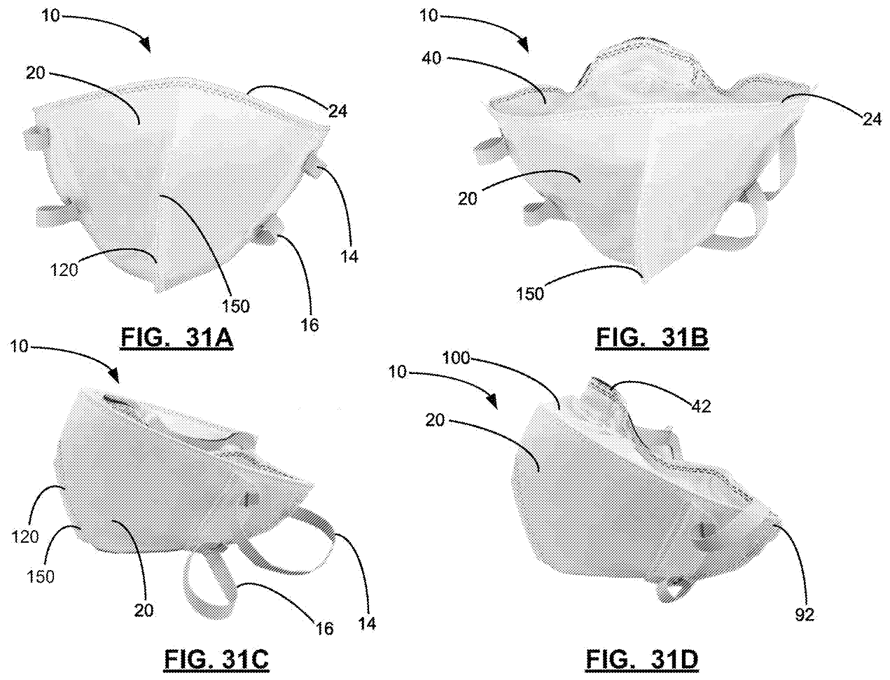

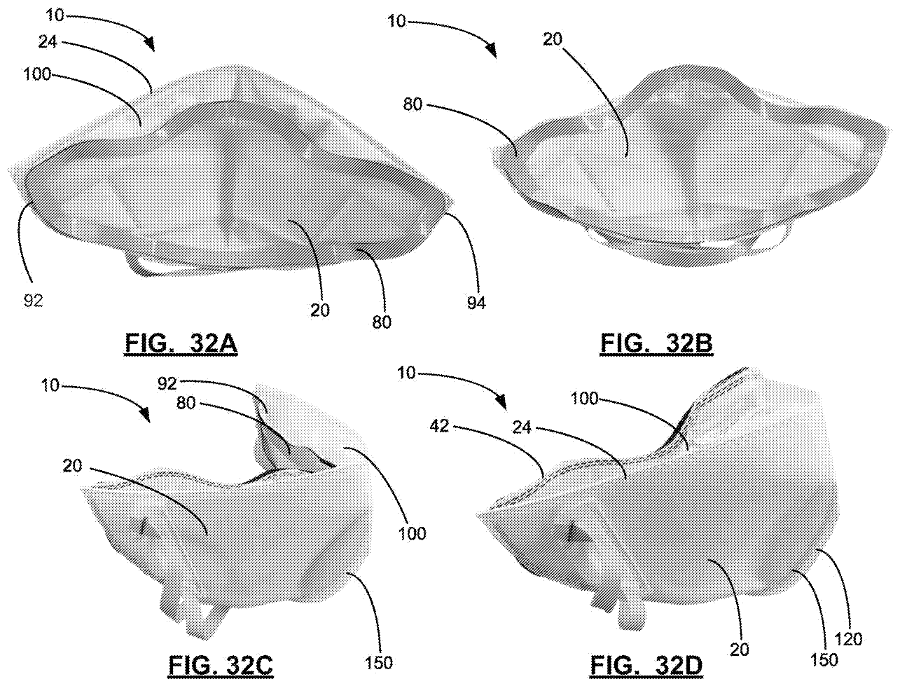

The rolling fold 100 may be any shape, size, and/or material (connector) that extends between the front panel 20 and the rear panel 40. The term rolling fold means that the fold is able to move between various positions to accommodate the motion of the user's jaw. In other words, the fold may move (or roll) forward and backward, up and down, and/or side to side to accommodate this motion. The fold may extend and contract and/or expand and compress to accommodate this motion. In some embodiments, this motion may be described as rolling due to the motion of the material that makes up the rolling fold 100. For example, a front portion of the fold may roll to a back portion when the user opens their jaw and may roll back to the approximately the original position when the user closes their jaw, as exemplified in FIGS. 24A-25B, 28A-28G, and 37A-38B. In some embodiments, the rolling fold may stretch in one or more areas to accommodate the user opening their jaw and may crumple and/or collapse in one or more areas when the user closes their jaw, as exemplified in FIGS. 31A-32D. In other words, the rolling fold may be a connector, such as a piece of excess fabric between the front panel 20 and the rear panel 40, that adapts to accommodate the motion of the user's jaw. The fabric may adapt in any way that allows the front panel 20 to move up and down with the user's jaw movement. In some embodiments, the excess fabric may be collapsible excess fabric. The collapsible excess fabric may be movable between a collapsed state when the respirator is in the closed mouth position and an extended state when the respirator is in the open mouth position. The collapsible excess fabric may be positioned in one or more areas. For example, the collapsible excess fabric may be positioned above and/or within the rear panel fold portion 104.

In some embodiments, a seam 90 may be used to assist with maintaining the rolling fold 100, as exemplified in FIGS. 14-19. As shown, the seam 90 may be positioned proximate the upper edge portion 24, thereby helping to maintain the rolling fold 100 between the front panel 20 and the upper rear panel 40.

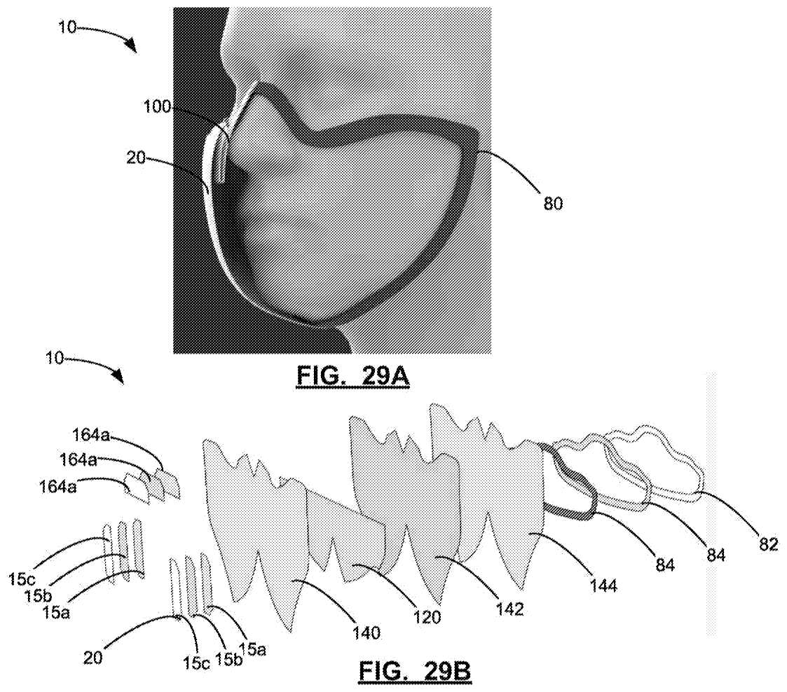

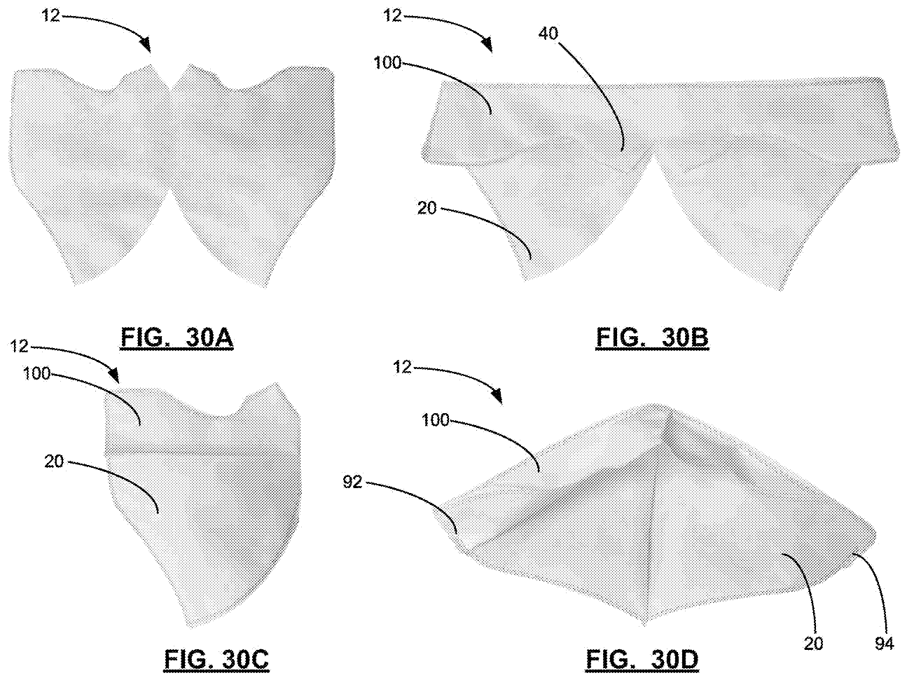

Similarly, in some embodiments, as exemplified in FIGS. 14-19 and 21-32D, a first side seam 92 and a second side seam 94 may be used to assist in maintaining the shape of the mask body 12 as the mask body 12 moves between the open position and the closed position.

Referring to FIG. 8, the rolling fold 100 may have a front panel fold portion 102, a rear panel fold portion 104 (also referred to as an upper nose panel fold portion), and optionally a rounded fold 106 extending therebetween. Accordingly, the front and rear panel fold portions 102, 104 may be coupled by the rounded fold 106 to form the rolling fold 100. In other words, the movable fold 100 may be formed by a juncture between the upper nose panel fold portion 104 and the front panel fold portion 102.

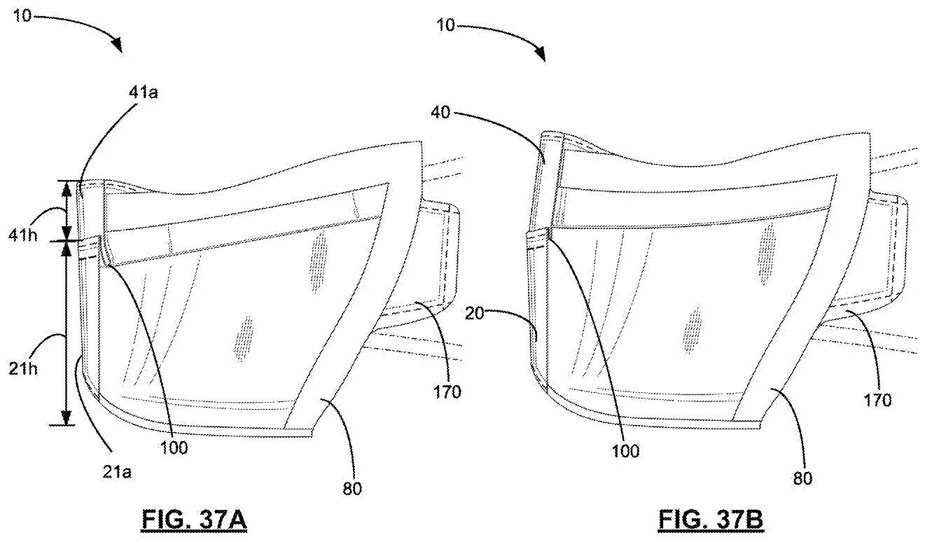

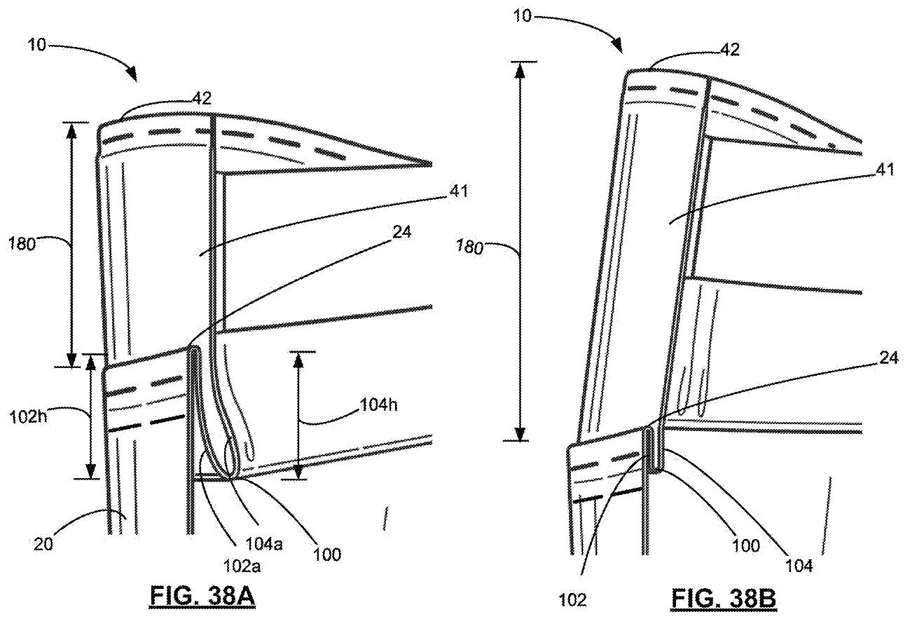

The front panel fold portion 102 may be located behind the front panel outer portion 21 of the front panel 20. Referring to FIGS. 37A-38B, the upper nose panel 40 includes the upper nose panel fold portion 104 and an upper nose panel free portion 41. The upper nose panel fold portion 104 may extend from the front panel fold portion 102 and may underlie the front mouth panel 20. The upper nose panel free portion 41 may extend upwardly from the upper nose panel fold portion 104 to an upper rear edge 42 (also referred to as the upper mask edge). A shown, the upper nose panel free portion 41 may be located above the front mouth panel 20. The front panel outer portion 21 and the upper nose panel free portion 41 may each be free of excess material and/or folds. For example, movable fold 100 may be the only fold formed by front mouth panel 20 and upper nose panel 40.

As exemplified, the front panel fold portion 102 may form an acute angle with the front panel 20. The front panel fold portion 102 projects inwardly and forms the rounded fold 106 with the rear panel fold portion 104. The rounded fold 106 is located at a turn position. As shown, the turn position may have a concave, or U-shaped, portion. In other words, the rounded fold 106 projects inwardly and turns back on itself. While this description is provided for the upper rolling fold 100a, it will be appreciated that, if present, the lower rolling fold 100b may have the same structure.

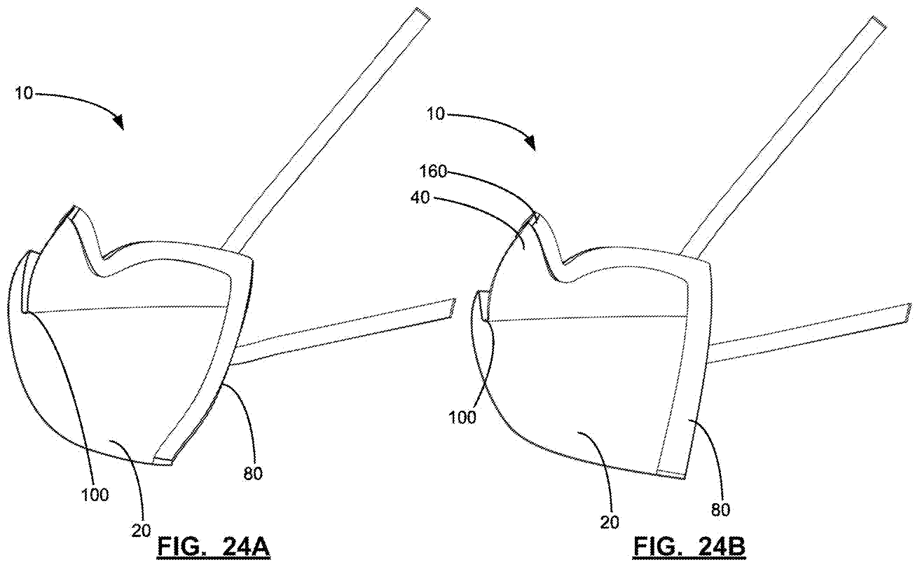

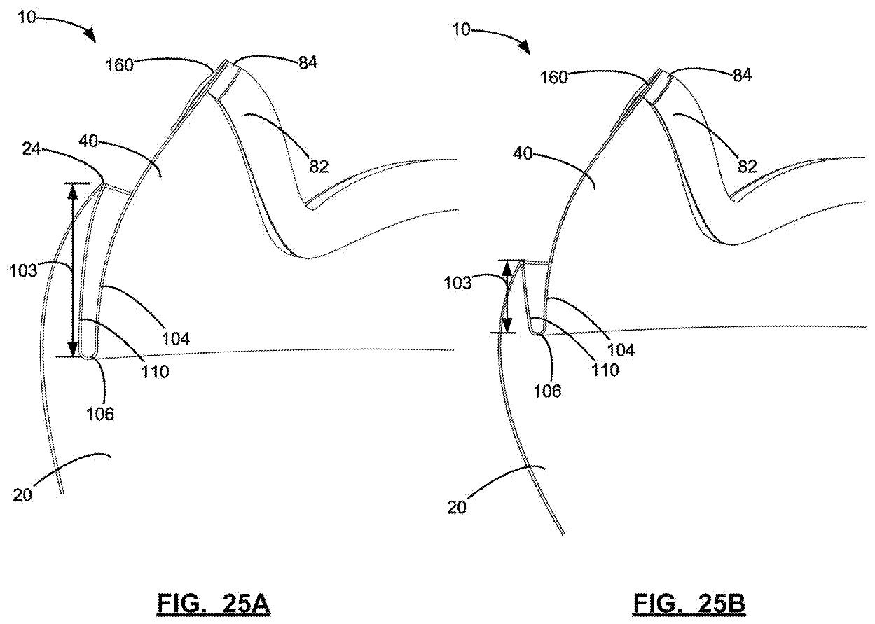

As shown in FIGS. 25A and 25B, the front panel fold portion 102 has a length 103 that extends from the upper edge portion 24 to the turn position of the rounded fold 106. As the user's jaw moves from a closed position to an open position, the length 103 is adjustable between a closed length and an open length. The length 103 of the front panel fold portion 102 is adjusted by the motion of the rounded fold 106. The turn position of the rounded fold 106 moves in response to user jaw movement. For example, when the user's jaw moves to the open position, the front panel 20 moves, causing the turn position of the rounded fold 106 to move towards the rear panel 40. Accordingly, the length 103 of the front panel fold portion 102 decreases. Similarly, when the user's jaw moves from the open position to the closed position, the front panel 20 moves, causing the turn position of the rounded fold 106 to move towards the front panel 20, thereby increasing the length 103 of the front panel fold portion 102.

In some embodiments, the rolling fold 100 may be constrained from flattening by excess material 110. The excess material 110 may be the length 103 of the front panel fold portion 102. Accordingly, the excess material 110 may remain folded at a maximum open jaw position during user jaw movement such that the length 103 remains greater than zero at the maximum open jaw position. Thus, the turn position of the rounded fold 106 does not overlap with the upper edge portion 22.

The size and/or shape of the movable fold 100 may vary depending on the size of the respirator and/or the desired use of the respirator. In some embodiments, the size of the movable fold 100 may be relative to a fold height ratio. For example, referring to FIGS. 37A-38B, at the horizontal centre of the mask body 12, the front panel outer portion 21 has a front panel outer portion height 21h, the nose panel free portion 41 has a nose panel free portion height 41h, the front panel fold portion 102 has a front panel fold portion height 102h, and the upper nose panel fold portion 104 has an upper nose portion height 104h. When the respirator is in the closed mouth position, a fold height ratio between a) a combined interior height of the front panel fold portion height 102h and the upper nose fold portion height 104h and b) a combined exterior height of the mouth outer portion height 21h and the nose panel free portion height 41h may be in the range of about 0.40 to about 0.65, optionally about 0.5 to about 0.6, optionally about 0.56.

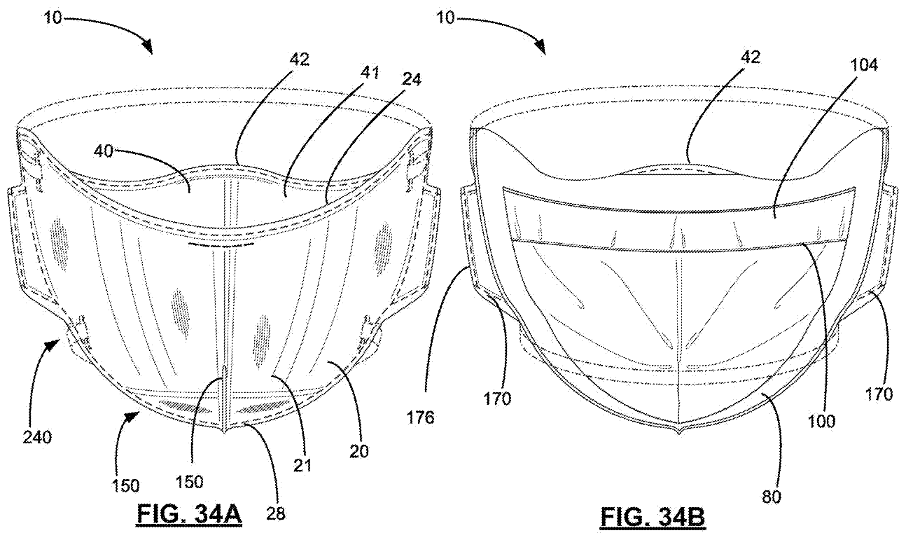

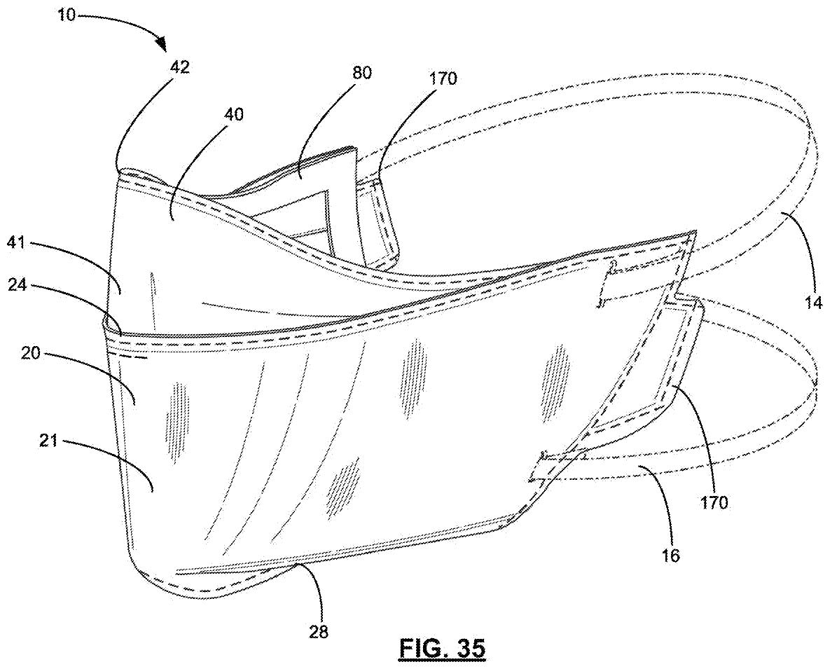

In some embodiments, the surface area of the movable fold 100 may vary depending on the size of the respirator and/or the desired use of the respirator. The surface area of the movable fold 100 may be relative to a fold surface area ratio. For example, referring to FIGS. 34A, 34B, and 37A-38B, the mouth outer portion 21 has a mouth outer portion surface area 21a, the nose panel free portion 41 has a nose panel free portion surface area 41a, the front panel fold portion 102 has a front panel fold portion surface area 102a, and the upper nose panel fold portion 104 has an upper nose fold portion surface area 104a. An interior fold surface area is formed by the front panel fold portion surface area 102a and the upper nose fold portion surface area 104a. An exterior mask body surface area may be formed by the mouth outer portion surface area 21a and the nose panel free portion surface area 41a. When the respirator is in the closed mouth position a fold surface area ratio between the interior fold surface area and the exterior mask body surface area may be about 0.40 to about 0.65, optionally about 0.5 to about 0.6, optionally about 0.56.

### Support Member

In some embodiments, the rolling fold 100 may be at least partially constrained from flattening by a support member 120. As exemplified in FIGS. 11 and 12, the support member 120 may be a frame that has an upper edge support member 122, a lower edge support member 124, a first side edge support member 126, and a second side edge support member 128. The first and second side edge support members 126, 128 extend between the upper edge support member 122 and the lower edge support member 124, thereby providing the support member 120. As exemplified in FIG. 12, the support member 120 may have a plurality of horizontal support members 130 and a plurality of vertical support members 132.

Accordingly, the upper edge support member 122 may be positioned within the upper edge portion 24, thereby constraining the upper edge portion 24 from folding. The upper edge support member 122 may also help constrain the front panel fold portion 102 to a non-zero length 103. Similarly, the lower edge support member 124 may be positioned within the lower edge portion 28, thereby constraining the lower edge portion 28 from flattening. In some embodiments, the support member 120 may bias the rolling fold 100 to its closed length.

The first and second side edge support members 126, 128 may provide resilience to the support member 120, further assisting in the maintenance of the rolling fold 100. Similarly, the plurality of horizontal support members 130 and vertical support members 132 may provide additional rigidity to the support member 120.

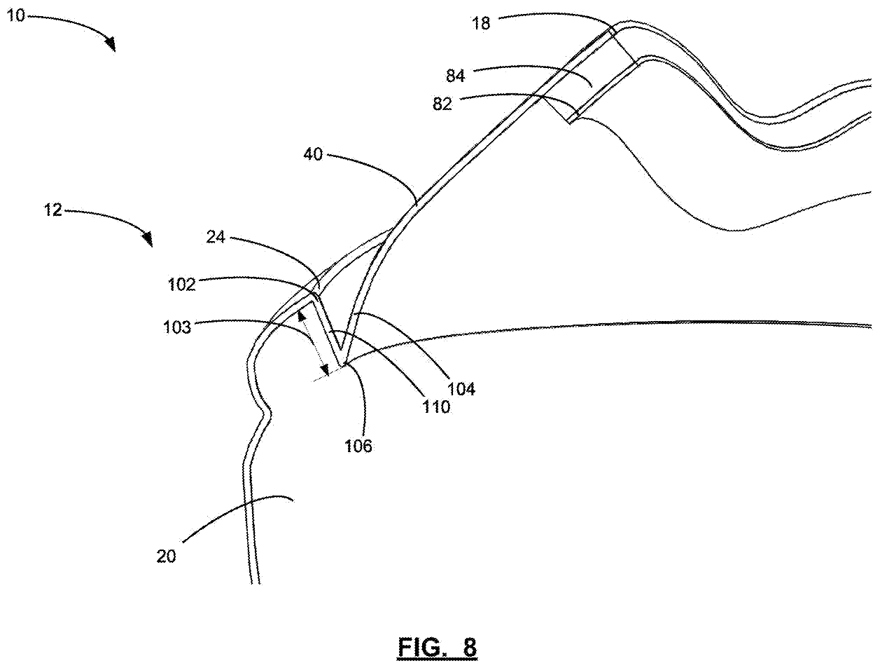

Additionally, the structure of the support member 120 provides a plurality of openings 136 throughout the support member 120. The openings 136 allow the support member 120 to provide stiffness to the respirator 10, with minimal to no impact to gas exchange as the user breathes. As exemplified in FIG. 13, in some embodiments, the openings 136 of the support member 120 may be covered by a covering material 138. The covering material 138 may be any air-permeable material.

In some embodiments, the support member 120 may be a sheet of material that is stiffer than the other panel materials in the mask body 12. For example, the support member 120 may be a heavier non-woven fabric than the front panel 20, upper rear panel 40, and/or lower panel 60. The stiffness of the support member 120 may be a naturally occurring stiffness caused by the material properties of the support member 120. Optionally the support member is at least 45%, 50% or 60% heavier, and optionally up to 75%, 100% or 150% heavier, than the front panel or upper rear panel, optionally measured in gsm weight for spunbond material). For example, the support member 120 may be a sheet of polypropylene that is spunbond and has a basis weight of 50 gsm, while the other panels in the mask body 12 may be made of a spunbond material with a basis weight of 30 gsm. The increased basis weight of the support member 120 may result in increased stiffness in the front panel 20, thereby allowing the support member 120 to constrain the rolling fold 100 from flattening. For example, the addition of the support member 120 to the front panel 20 may increase the stiffness of the front panel by greater than about 1000% (e.g. 1000% to 3000%), optionally greater than about 1200%, optionally about 1400%.

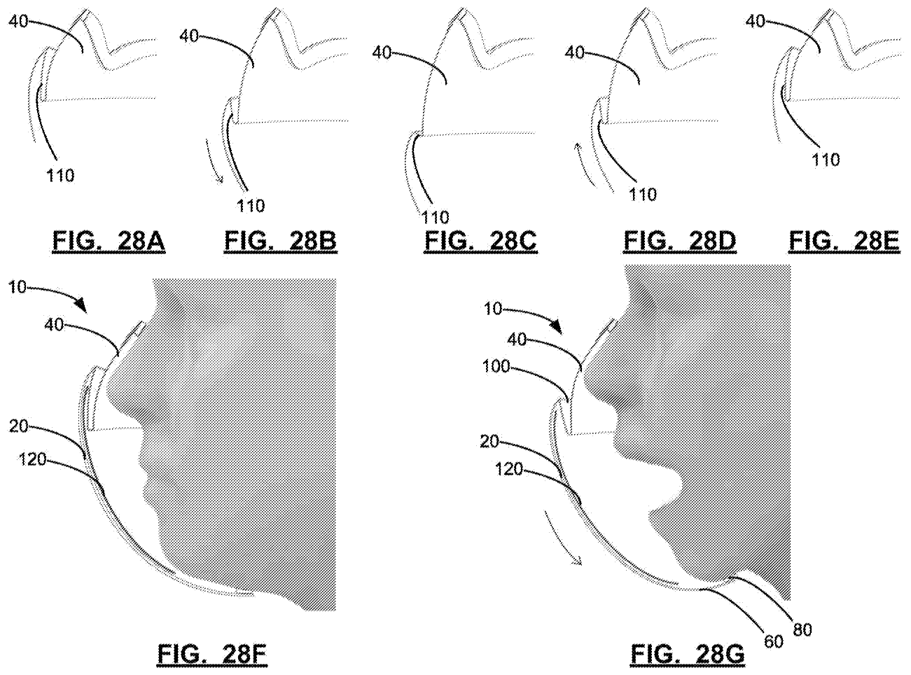

For example, as exemplified in FIGS. 21A-32D, the support member 120 is a single sheet that is stiffer than the other panel materials of the mask body 12. As shown in FIGS. 28F-28G, the support member 120 extends from the upper edge portion 24 along a substantial portion of a length of the front panel. It will be appreciated that the support member 120 may be any length such that the upper edge portion 24 is mechanically linked to the lower edge portion 28. In other words, the support member 120 may facilitate the movement of the front panel 20 such that the front panel 20 moves with the motion of the user's jaw.

In some embodiments, as exemplified in FIGS. 28F and 28G, the support member 120 may extend to proximate the user's chin. The remaining material between the support member 120 and the perimeter 18 of the mask body 12 may be referred to as the lower panel 60. By having a portion of the front panel 20 without the support member 120, the user may more easily adhere the respirator 10 to their face, while still maintaining the mechanical linkage between the upper edge 24 and the lower edge 28.

In some embodiments, as exemplified in FIG. 36B, the front panel 20 may include a mouth portion 240 and a chin portion 250 and the support member 120 may be positioned within the mouth portion 240. The mouth portion 240 may extend from the upper edge 24 to proximate a top edge 151 of the spine 150, alternatively extending slightly below the top edge 151 of the spine 150. The support member 120 may be positioned exclusively within the mouth portion 240.

The rolling fold 100 may operate to decouple the rear panel 40 from the front panel 20 such that the front panel 20 is independently movable from the rear panel 40. For example, the excess material 110 in the fold 100 may allow the front panel 20 to move with the movement of the user's jaw while maintaining the position of an upper rear edge 42 of the upper rear panel. For example, the excess material 110 may be adjustable between the open length when the rolling fold 100 is in the open position and the closed length when the rolling fold is in the closed position. The open length may be less than the closed length, such that as the user moves their jaw from closed to open, the length of the excess material 110 decreases. In other words, the excess material 110 enables the use to move their jaw without impacting the position of the upper rear edge 42.

For example, referring to FIGS. 25A-25B and 28A-28G, as the user moves their jaw from the closed position to the open position, the movement causes the front panel 20 to move downwardly. This downward movement causes the excess material 110 in the rolling fold 100 to at least partially move to the upper rear panel side (e.g., FIGS. 28A-28C), thereby reducing the amount of excess material 110 in the rolling fold. The excess material 110 may continue to reduce in length until the user's jaw is fully opened (e.g., FIGS. 28C and 28G). When the user closes their mouth, the mechanical link between the user's jaw and the upper edge portion 24 causes the excess material 110 to return proximate the front panel 20 until the respirator 10 returns to the fully closed position (e.g., FIGS. 28A, 28E, 28F).

The excess material 110 may have a length such that the user can move their jaw from the closed position to the fully open position, while minimizing or eliminating the transfer of force to the upper rear edge 42. Accordingly, with the front panel mechanically linked with the user's jaw by the support member 120 and the front panel 20 mechanically decoupled from the upper rear edge 42, the user may move their jaw through a full range of motion while minimizing the transfer of force to the upper rear edge 42, thereby improving the fit of the respirator 10.

The support member 120 may also assist with maintaining the structure of the respirator 10 by preventing collapse of the mask body 12 as the user inhales and preventing the mask body 12 from bellowing as the user exhales. Maintaining the shape of the mask body 12 helps manage dead volume inside the mask, which may improve gas exchange through the respirator 10.

In some embodiments, as exemplified in FIGS. 21A-32D, the front panel 20 may have a spine 150. As shown in FIGS. 21A and 22A, the spine extends from proximate the upper edge portion 24 to proximate the lower edge portion 28. The spine 150 may operate to support the shape of the front panel 20 and the mask body 12 such that the interior volume within the respirator 10 is maintained.

In some embodiments, the spine 150 may be formed by at least a portion of the support member 120. For example, as shown in FIG. 21A, the spine 150 is formed by a seam 152 in the front panel. The seam 152 may include the support member 120 such that the spine 150 is supported by the support member 120. The spine 150 may reinforce the mechanical linkage between the lower edge portion 28 and the upper edge portion 24.

As exemplified in FIGS. 21A and 22A, the spine 150 may have a height 154 that is normal to the front panel 20. As shown, the height 154 decrease as the spine 150 approaches the upper edge portion 24. This taper may assist in maintaining the convex shape of the front panel 20. The taper may also improve the decoupling of the upper rear panel 40 from the front panel 20.

In some embodiments, one or more seams in the respirator 10 may at least partially constrain the rolling fold 100 from flattening. For example, as shown in FIG. 22B, the first side seam 92 and the second side seam 94 are fixed in length. This fixed length may assist with the movement of the rolling fold 100 such that the rolling fold 100 is movable between the open position and the closed position. By fixing both ends of the rolling fold 100, the amount of excess material 110 proximate the first seam 92 and the second seam 94 may be maintained. For example, as the user moves their jaw from the closed position to the open position, the excess material 110 between the first seam 92 and the second seam 94 may decrease until the user's jaw is fully opened, with the excess material proximate the first seal 92 and the second seam 94 being unaffected by the motion of the user's jaw.

In some embodiments, the first seam 92 and the second seam 94 may operate to bias the rolling fold 100 to the closed position. Since the length of seams 92, 94 are fixed at the terminal ends of the rolling fold 100, as the excess material 110 decreases due to motion of the user's jaw, the height of the rolling fold 100 is maintained at the ends. Accordingly, force applied to the excess material 110 by the mechanical linkage between the front panel 20 and the user's jaw pulls on the excess material 110, creating a bias from either terminal end to approximately the mid-point of the rolling fold 100. As the user closes their jaw, the force applied to the excess material 110 is reduced, and the bias between the excess material 110 and the seams 92, 94 facilitates the increasing length of the excess material 110, thereby helping to return the rolling fold 100 to the closed position.

The first seam 92 and the second seam 94 may be positioned at the hinge point of the user's jaw, such that the rolling fold 100 is hinged proximate the hinge point of the user's jaw. Accordingly, since the hinge points of the jaw and rolling fold 100 are aligned, the respirator 10 moves with the opening and closing of the jaw, thereby allowing isolating the applied force to the excess material 110, while minimizing the force applied to the perimeter 18 of the mask body 12.

The first seam 92, second seam 94, and support member 120 may operate together to improve the mechanical linkage between the jaw of the user and the upper edge portion 24 of the front panel 20. By fixing the ends of the fold 100 at the first seam 92 and the second seam 94, and providing the support member 120, isolation of stress caused by the motion of the user's jaw in the excess material 110 may be improved. In some embodiments, the spine 150 may also improve the stress isolation in the excess material 110 in combination with the first seam 92, the second seam 94, and the support member 120.

Referring to FIG. 11, shown therein is an exploded view of the respirator 10. As shown, the mask body 12 is formed of a mask filter material, for example, a fabric with suitable filter properties. In this case, the mask body 12 is formed of a material that comprises spunbond-meltblown-spunbond (SMS) structure. For example, the SMS laminate structure may be N95 fabric. Accordingly, there is a first spunbond layer 140, a meltblown layer 142, and a second spunbond layer 144. Each of the layers may be made of the same material, such as polypropylene, or may be made of different materials. The first spunbond layer 140 provides a first layer of defense and may operate as a filter layer, providing resistance to moisture from outside of the respirator 10. The meltblown layer 142 may act as the filter media in the respirator 10. In some embodiments, the meltblown layer 142 may be imparted with an electrostatic charge to aid in the capture of particles. The second spunbond layer 144 may be the same as the first spunbond layer, however, the second spunbond layer 144 may operate to protect the meltblown layer 142 from moisture in the user's breath.

In some embodiments, the support member 120 may be made of a spunbond material such as polypropylene. The support member 120 may be positioned between the meltblown layer 142 and the second spunbond layer 144. Thus, the support member 120 provides rigidity to the mask body 12, with minimal to no impact to gas exchange.

As exemplified in FIG. 11, in some embodiments, the front panel 20, upper rear panel 40, and lower rear panel 60 may consist of a single laminated sheet of material. In some embodiments, each of the front panel 20, upper rear panel 40, and lower rear panel 60 may each be formed of separate sheets of material. In such embodiments, the panels may be coupled together by any means, including, but not limited to heat sealing, ultrasonic bonds, adhesive, or any combination thereof.

### Facial Attachment Seal

In accordance with this aspect, which may be used by itself or in combination with one or more other aspects, the respirator 10 may have a facial attachment seal 80 for sealingly connecting the respirator 10 to the skin of the user. The facial attachment seal 80 may extend along the edge 18 of the perimeter of the mask body 12. An advantage of this aspect is that the facial attachment seal 80 may improve the contact between the respirator 10 and the face of the user, thereby improving the efficacy of the respirator 10. For example, sealing the entire perimeter 18 of the respirator 10 may reduce leakage, thereby improving the safety of the user and others.

In accordance with this aspect, in some embodiments, the facial attachment seal 80 has an adhesive layer 82 and a contour layer 84. The adhesive layer 82 provides adhesion of the mask body 12 to the skin of the user. The adhesive layer 82 may be made of a biocompatible adhesive material. In some embodiments, the adhesive layer 82 may include a pressure sensitive adhesive that is biocompatible, such as medical silicone tape or acrylic tape. The adhesive layer 82 may also include, but is not limited to, hydrocolloid adhesives, hydrogels, or silicone gaskets. In some embodiments, the facial attachment seal 80 may be formed of a single layer made of a hydrocolloid adhesive that may operate both as the contour layer and the adhesive layer.

The contour layer 84 provides flexibility and shock absorbency to the seal. The contour layer 84 may also be referred to as a conformable layer that conforms to fit the user's face shape. The compliance of the contour layer 84 may reduce sheer forces applied to the skin of the user. For example, the contour layer 84 will stretch before sheer forces are applied to the skin of the user, thereby improving the comfort of the user. In some embodiments, the contour layer 84 may include, but is not limited to, an open cell foam or a closed cell foam. For example, the contour layer 84 may be formed of an open cell foam with more than 100 pores/inch to improve the breathability of the seal 80. In some embodiments, the contour layer 84 is a foam that is at least as elastic as the skin of the user. Such elasticity minimizes the pull on the skin, thereby improving the comfort of the user. The contour layer 84 may be made of, for example, ethylene-vinyl acetate.

Together, the adhesive layer 82 and the contour layer 84 may improve the comfort of the user, while also reducing leakage through the perimeter 18 of the mask body 12. Furthermore, the use of the adhesive layer 82 and contour layer 84 may allow a user to position and re-position their mask as necessary. For example, a user may re-position the mask three or more times without impacting the seal 80. Accordingly, the user may wear the respirator 10 for an extended period of time, such as longer than six hours.

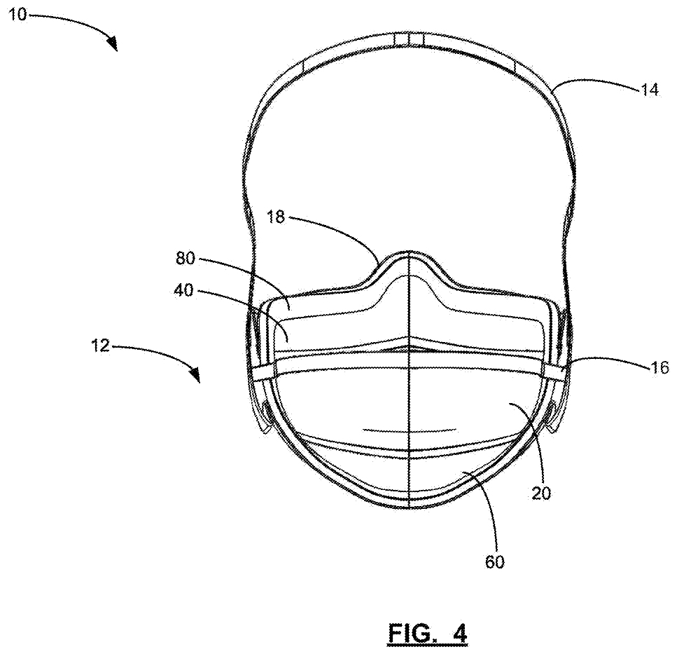

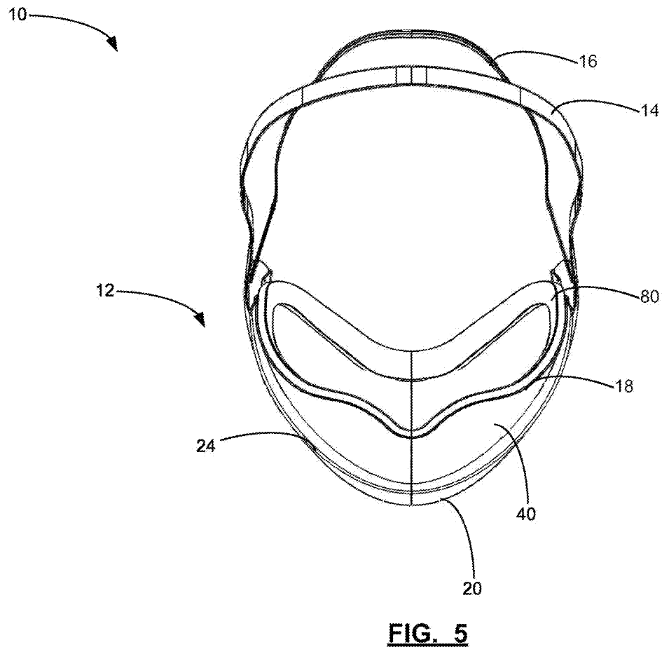

As exemplified in FIGS. 4 and 5, the seal 80 may extend along the entire perimeter 18, optionally as a single piece seal (unitary seal). In some embodiments, the seal 80 may extend only partially along the perimeter 18 as long as a suitable seal is still maintained at the perimeter by the other respirator components. Similarly, in some embodiments, the adhesive layer 82 may extend around the entire perimeter 18 or may extend only partially along the perimeter 18, as long as a suitable seal is maintained at the perimeter by the other respirator components. In some embodiments, the seal 80 may be formed by joining two or more pieces together to extend along the perimeter 18.

The seal 80 may also maintain contact with the skin of the user as the rolling fold 100 moves between the closed length and the open length. The adhesive layer 82 provides additional stickiness to the respirator 10 during motion of the user's jaw, while the contour layer 84 provides additional compliance to the seal 80. Accordingly, the seal 80 remains in contact with the skin of the user throughout the entire range of motion of the jaw of the user.

The seal 80 may improve the mechanical linkage between the lower edge portion 28 and the upper edge portion 24. The seal 80 may act to pin the perimeter 18 of the mask body 12 to the user's face, thereby improving the transfer of force from the user's jaw as the user's jaw moves between the closed position and the open position.

Additionally, the seal 80 may reduce the force required to hold the respirator 10 to the skin of the user. The combination of adhesive 82 and contour layer 84 may improve the adhesion and compliance of the respirator 10 such that the straps 14 and 16 may not be needed to secure the respirator 10 to the face of the user. Accordingly, a reduction in force required to hold the respirator 10 to the face of the user may improve the comfort of the user.

As exemplified, each of the adhesive layer 82 and the contour layer 84 has a uniform thickness. It will be appreciated that, in some embodiments, the thickness of each layer may vary to compensate for contours in the face of the user.

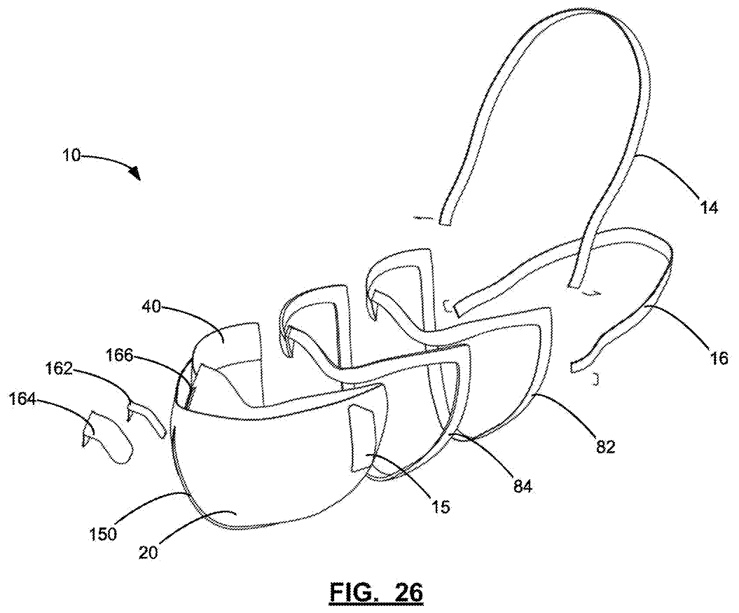

In some embodiments, as exemplified in FIGS. 21A-27, the mask body 12 may include a nose attachment portion 160. The nose attachment portion 160 may be made of any material capable of improving the fit of the mask body 12 to the face of the user. For example, the nose attachment portion 160 may be made of a metal, including, but not limited to, aluminum. As shown in FIG. 26, the nose attachment portion 160 has a metal portion 162 and a fabric portion 164 covering the metal portion 162. As exemplified in FIG. 27, the fabric portion 164 may be made of a spunbond layer 164a, a meltblown layer 164b, and a second spunbond layer 164c. During use, the user may pinch the nose attachment portion 160 to conform to the shape of their nose, thereby improving the fit of the mask body 12. The nose attachment portion 160 may improve the attachment of the seal 80 to the face of the user.

As shown, the nose attachment portion 160 is positioned proximate the upper rear edge 42 of the upper rear panel 40. The nose attachment portion 160 may facilitate the decoupling of the front panel 20 from the upper rear panel 40 by securing the location of the upper rear edge 42 on the face of the user, thereby making the upper rear edge 42 less likely to be impacted by force applied to the upper rear panel 40 caused by motion of the jaw of the user.

In some embodiments, the nose attachment portion 160 may be positioned proximate a nose seam 166. The nose seam 166 may help to maintain the shape of the upper rear panel 40.

### Tabs

The mask body 12 may including one or more tabs. The tabs may be used to pull the mask body 12 from the face of the user after use. An advantage of this design is that a user may remove the respirator from their face without contacting the front panel 20. After use, the front panel 20 may contain bio contaminants that a user may wish to avoid contacting with their hands to prevent spread of the contaminants. The tabs may be located outside of a gasketed perimeter of mask body 12, and as such may not provide any air filtration functionality. Consequently, the tabs may be substantially free of bio contaminants.

Referring to FIGS. 36A-36B, the mask body 12 is shown including tabs 170. As shown, the front panel 20 includes laterally spaced part first and second rear edges 23. Each rear edge 23 includes an upper portion 23a, a lower portion 23b, and a tab 170 between upper portion 23a and lower portion 23b. Tabs 170 project rearwardly compared to the upper portions 23a and the lower portions 23b.

The tabs 170 may be any size and/or shape suitable to facilitate the removal of the respirator from the face of the user. The tabs 170 may have a height 172 and a width 174. For example, the height 172 may be greater than a height of the upper portion 23a and smaller than a height of the lower portion 23b. As shown, a height of each of the upper portion 23a and lower portion 23b may be at least 25% (e.g. 25% to 200%) of the height 172. In some embodiments, height 172 may be between 25% and 65% of a height of rear edge 23. The width 174 may be large enough such that the tab 170 protrudes further back than both the upper portion 23a and the lower portion 23b. As exemplified in FIGS. 36A-36B, the width 174 may vary along a vertical axis of the tab 170. For example, as shown, the tab 170 has a rear tab edge 176 that is generally vertical with the width increasing from the top of the rear tab edge 176 to the bottom of the rear tab edge 176. In some embodiments, the height 172 and/or width 174 may be large enough to receive a finger of the user to pull the tab 170. In some embodiments, the rear tab edge 176 may be curved.

As exemplified in FIG. 34B, the tabs 170 may be located rearward of the facial attachment seal 80. For example, the tabs 170 may be entirely located rearward of the facial attachment seal 80. This positioning may enable a user to remove the respirator from their face without contacting the facial attachment seal 80 and/or the front panel 20.

Referring to FIGS. 36A-36B, the first strap 14 may be attached to the mask body 12 above the tab 170 of each rear edge 23 and the second strap may be attached to the mask body 12 below the tab 170 of each rear edge 23. This positioning may improve the distribution of forces of the straps across the head of the user, thereby improving the user's comfort. In some embodiments, this positioning of the straps may reduce the force acting on the facial attachment seal 80, assisting in the maintenance of the adhesion throughout a range of motion of the user's jaw.

### Mask Body Shape

The mask body 12 may be shaped to improve the fit of the respirator 10 and the comfort of the user. For example, referring to FIG. 9, the user 200 has a nose area 210, a jaw area 220, and temporomandibular joints 230. As illustrated, the mask body 12 is shaped to be high (i.e., between the nose area 210 and jaw area 220) and wide (i.e., between temporomandibular joints 230). This high and wide design improves the comfort of the user by minimizing contact of the perimeter with the muscles of mastication and muscles of communication of the user. In other words, the perimeter 18 may be shaped to avoid the large muscle fibers in the face of the user. Avoiding the large muscle fibers allows the perimeter 18 to cross the facial muscles at areas of minimized contraction. Accordingly, when the user moves their jaw, the areas of minimized contraction move less than other areas. By crossing these minimized areas of movement, the respirator 10 may remain in contact with the user's skin more easily, improving the comfort and efficacy of the respirator 10.

Additionally, avoiding the large muscle fibers may reduce the necessary force required to secure the respirator 10 to the face of the user. Reducing the necessary force may improve the comfort of the user, protecting the soft tissue of the cheeks of the user. This reduction in force may reduce the likelihood of bruising. As described above, the reduction in required force may also be a result of the adhesive layer 82 improving the contact between the respirator 10 and the face of the user.

In some embodiments, as exemplified in FIGS. 14-19, the upper rear panel 40 may include one or more peaks that may improve the fit of the mask body 12 on the face of the user 200. For example, referring to FIG. 14A, the upper rear panel 40 has a first peak 17 and a second peak 19 that extend along the perimeter 18 of the mask body 12.

Similarly, avoiding the large muscle fibers allows the user 200 to enunciate spoken words more clearly, thereby improving the audibility of the respirator 10. The audibility is also improved as a result of the increased breathability and surface area of the respirator 10.

Referring to FIGS. 18A-19B, shown therein are exemplary manufacturing steps to assemble the respirator 10. As shown in FIG. 18A, an exterior weld 96 is used to seal the outer sides of the mask body 12. This exterior weld 96 may also position the support member 120 in the mask body 12. As shown in FIG. 18B, the weld 90 may be used to secure the position of the support member 120 and to create the bottom edge of the rolling fold 100. As shown in FIG. 19A, a nose weld 98 is used to seal the nose and chin sections of the mask body 12. As shown in FIG. 19B, the lower portion of the mask body 12 is inverted so that the seams are internal. Side seams 92 and 94 may then be used to secure the inverted sides of the mask body 12, thereby securing the rolling fold 100 at the peripheral edges proximate the seams 92 and 94, while allowing the rest of the rolling fold 100 to move with the jaw of the user 200.

Another aspect of the disclosure relates to a method of manufacturing a mask by sealing the outer sides of the mask body 12, optionally also welding the support member 120 in the mask body 12 to create the bottom edge of the rolling fold 100. The method further comprises the step of welding a nose weld 98 to seal the nose and chin sections of the mask body 12. The method further comprises welding side seams 92 and 94 to secure the inverted sides of the mask body 12, thereby securing the rolling fold 100 at the peripheral edges proximate the seams 92 and 94, while allowing the rest of the rolling fold 100 to move with the jaw of the user 200.

In some embodiments, the front panel fold portion 102 may be rigidly attached by a rigid attachment 99 to the front panel outer portion 21 to constrain the front fold portion 102 from flattening. The rigid attachment 99 may be a weld securing the front panel outer portion 21 to the front fold portion 102. The rigid attachment 99 may be positioned in a central region of the front panel 20 at a location below the upper mouth panel edge 24.

One or more components of the respirator 10 may operate in combination to maintain the shape and movement of the mask body 12. For example, the support member 120 may operate to maintain a cup-like shape of the front panel 20. Maintaining the cup-like shape of the front panel 20 improves the gas-exchange of the respirator 10, while also maintaining a space between the user's mouth and the mask body 12. The spine 150 may also operate to maintain the shape of the mask body 12. In some embodiments, as described above, the spine 150 may be formed at least partially by the support member 120. Accordingly, the spine 150 and the support member 120 may operate together to maintain the shape of the front panel 20. In some embodiments, the seal 80 and the excess material 110 of the rolling fold may facilitate the maintenance of the shape of the mask body 12. For example, seal 80 may maintain the fit of the mask body 12 on the face of the user and the excess material 110 of the rolling fold 100 allows for the user's jaw to open and close while minimizing the forces exerted on the seal 80. Accordingly, stress applied to the mask body 12 may be at least partially isolated or entirely isolated in the excess material 110, reducing stress applied elsewhere that may cause deformation of the mask body 12. The seal 80 and excess material 110 may be used in combination with the spine 150, the support member 120, and/or the first seam 92 and second seam 94 to maintain the shape of the mask body 12 throughout a range of motion of the user's jaw.

### Performance

It will be appreciated that the design of the respirator 10 as described herein may improve the comfort, fit, and performance of the respirator 10. For example, as described above, each of the front panel 20, upper rear panel 40, and lower rear panel 60 extend between the temporomandibular joints 230 of the user 200.

The high and wide fit along with the at least one rolling fold 100 provides an increased surface area of the mask body 12. In some embodiments, one or more of the front panel 20, upper rear panel 40, or lower rear panel 60 may have additional pleats and/or indentations to increase the surface area of the respirator 10. Increased surface area results in improved gas exchange, as there is more material to filter the gas. Furthermore, the at least one rolling fold 100 provides for additional material to the respirator 10, without increasing the dead volume within the respirator 10. Increasing the surface area without also increasing the dead volume within the respirator 10 may improve the gas exchange of the respirator 10. For example, in some embodiments, the surface area as compared to a traditional N95 mask may be increased by 10-60%, optionally 20-55%, optionally 54%. In some embodiments, the respirator 10 may have various sizes to accommodate for varying face shapes of a user. Accordingly, the relative surface area increase may vary depending on the size of the respirator 10.

Additionally, the excess material 110 of the rolling fold 100 may also increase the surface area of the mask body 12. Since the excess material 110 adjusts with the motion of the user's jaw, the excess material 110 provides additional surface area for gas exchange of the respirator 10.

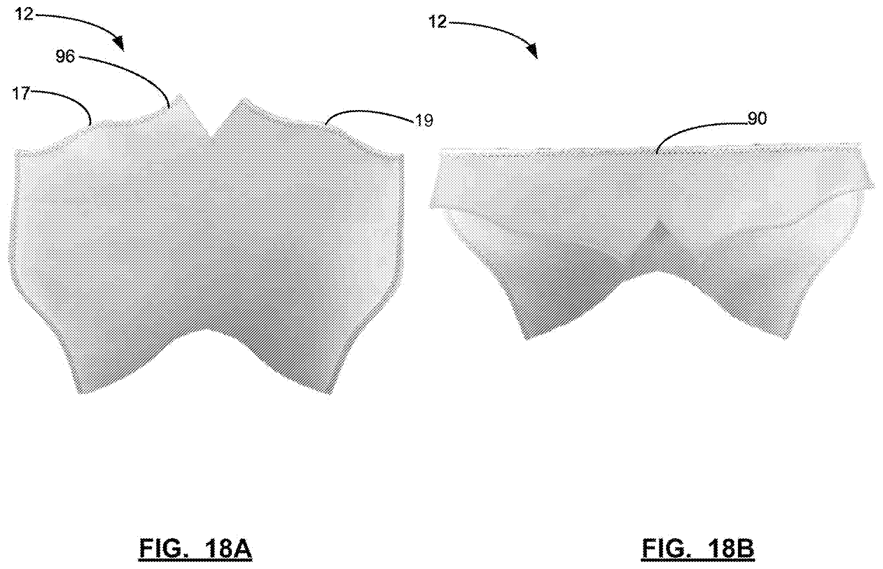

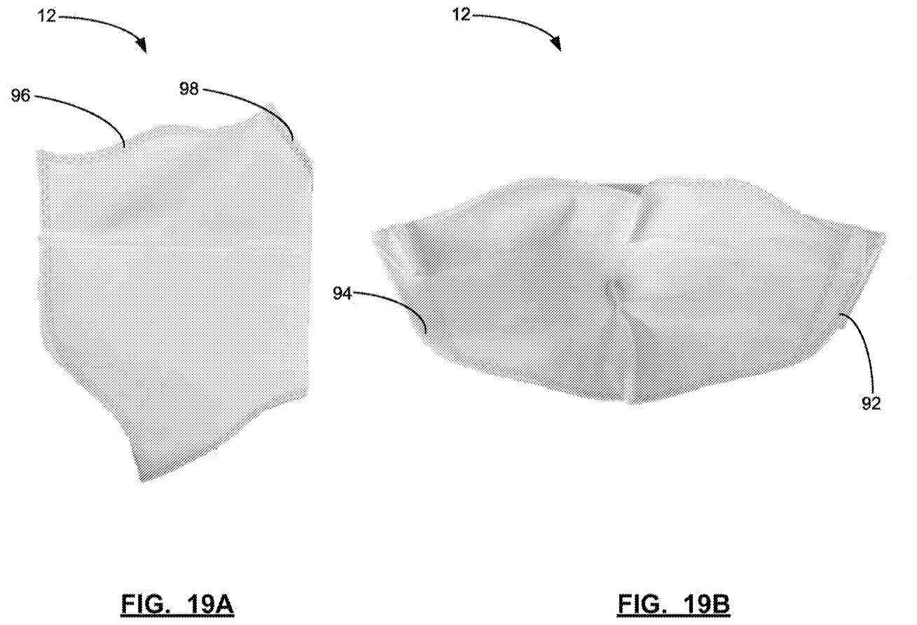

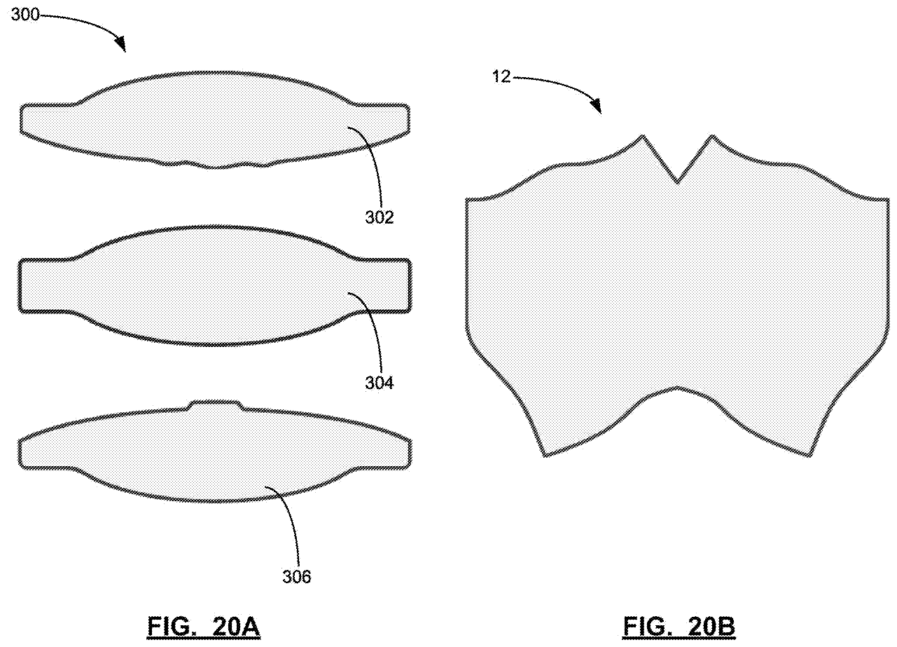

For example, a traditional N95 mask, the 3M 1870, is shown in FIG. 20A with each panel 302, 304, and 306 in an unassembled position, while FIG. 20B shows the mask body 12 in an unassembled position. The surface area of panel 302 is 8158.27 mm², the surface area of panel 304 is 12058.39 mm², and the surface area of panel 306 is 9541.37 mm², resulting in a combined surface area of 29758.03 mm². In contrast, the mask body 12 shown in FIG. 20B has a surface area of 40066.95 mm². Accordingly, the mask body 12 has 34.6% more surface area than the 3M 1870.

In another example, the mask body 12 shown in FIGS. 21A-32D has a surface area of 49038.1 mm². Accordingly, the mask body 12 has 65% more surface area than the 3M 1870.

The increase in surface area may result in increased gas exchange, thereby reducing respiratory resistance and reducing the pressure drop as a user breathes. Reducing the pressure drop provides less restriction or effort required for breathing by the user. Furthermore, increased gas exchange combined with minimized dead volume may lead to improved carbon dioxide levels due to more rapid gas diffusion. The rate of gas diffusion in the respirator 10 is proportional to the surface area of the mask. As a result, the breathability and comfort of the mask may be improved. In other words, a larger surface area may reduce the inhalation resistance experienced by a user.

When a user experiences flow restriction, or inhalation resistance, during breathing they may feel claustrophobic because they cannot breathe as easily. Even mild flow resistance may reduce the performance of a user wearing the mask, due to the increased carbon dioxide levels. Accordingly, increasing the rate of diffusion through the respirator 10 may result in a reduced feeling of claustrophobia to the user wearing the respirator 10 and may also result in improved physical and cognitive performance.

During inhalation, the exhaled air trapped in the dead space between the mask body 12 and the face of the user is re-inhaled, leading to an increase in the concentration of inhaled carbon dioxide and a reduction in inhaled oxygen. Over extended use, the user may experience discomfort and fatigue. If the dead space volume is relatively large compared to the tidal volume (i.e., volume of a typical inhalation and exhalation), the inhaled carbon dioxide fraction can approach the fraction of carbon dioxide at peak exhale. This fractional value is typically around 5% for conventional respirators. In contrast, the increased surface area and reduction of dead volume of the respirator 10 may result in a fraction of inhaled carbon dioxide of around 2%. This reduction in inhaled carbon dioxide may reduce claustrophobia and fatigue in the user.

Additionally, increasing the gas diffusion in the respirator 10 may reduce moisture build-up within the mask body 12. Reducing moisture build-up may improve the skin quality of the user, by reducing the likelihood of a user experiencing dermatitis. In some embodiments, the respirator 10 may include a desiccant in the mask body 12 to assist with the removal of moisture when worn by the user. In some embodiments, the respirator 10 may include a super absorbent polymer (SAP) for assisting in the removal of moisture.

Tests are conducted on the N-95 mask, for example, in accordance with NIOSH Procedure No. TEB-APR-STP-0059 (Dec. 13, 2019 revision 3.2). The filtering elements including the filter holders and gaskets are tested for particle penetration. The respirator filters are challenged by a NaCl aerosol at 25+/−5 C and a relative humidity of 30+/−10%. The NaCl aerosol penetration is tested, and it is determined that the minimum efficiency for the respirator is greater than 95%. The respirator 10 is determined to conform to relevant medical mask standards, such as: National Institute for Occupational Safety and Health (NIOSH), Title 42 Code of Federal Regulations, Part 84 (42 CFR 84), FDA Surgical Apparel 21CFR 878.4040, EN 149:2001 FFP2, EN 14683, Type IIR.

The following is an example of fit testing that was performed using a Porta-Count machine. The result of such testing is a Fit Factor for each respirator tested. The Porta-Count machine operates by measuring the concentration of microscopic particles in the ambient air and compares this value to the concentration of those that leak into the respirator. The respirator fabric filters out the particles, so that any leak indicates ingress through the face seal. In order to receive a pass, an N95 mask must have a Fit Factor of greater than 100, with a maximum recordable value of 200+.

In this example, twelve respirators were tested, with two respirators failing due to user error. All ten respirators passed the Fit Factor test, achieving a Fit Factor of greater than 100. The average Fit Factor for the ten masks was 191.8. The median Fit Factor for the ten masks was 200.

While the above description describes features of example embodiments, it will be appreciated that some features and/or functions of the described embodiments are susceptible to modification without departing from the spirit and principles of operation of the described embodiments. For example, the various characteristics which are described by means of the represented embodiments or examples may be selectively combined with each other. Accordingly, what has been described above is intended to be illustrative of the claimed concept and non-limiting. It will be understood by persons skilled in the art that other variants and modifications may be made without departing from the scope of the invention as defined in the claims appended hereto. The scope of the claims should not be limited by the preferred embodiments and examples, but should be given the broadest interpretation consistent with the description as a whole.

1. A respirator for filtering respirated air by covering a nose area to a jaw area of a user, comprising:
a mask body having:
a front mouth panel having a front panel outer portion extending from an upper mouth panel edge to a lower chin edge and a front panel fold portion extending from the upper mouth panel edge, the front panel fold portion located behind the front panel outer portion; and
an upper nose panel having an upper nose panel fold portion and an upper nose panel free portion,
the upper nose panel fold portion extending from the front panel fold portion and underlying the front mouth panel, and the upper nose panel free portion extending upwardly from the upper nose panel fold portion to an upper mask edge, the upper nose panel free portion located above the front mouth panel,
a juncture of the upper nose panel fold portion and the front panel fold portion being a movable fold;
the movable fold being upwardly movable between a closed mouth position and an open mouth position, an edge spacing between the upper mask edge and the upper mouth panel edge being greater in the open mouth position than in the closed mouth position.

2. The respirator of claim 1, wherein:
at a horizontal center of the mask body,
the front panel outer portion has a front panel outer portion height,
the nose panel free portion has a nose panel free portion height,
the front panel fold portion has a front panel fold portion height, and
the upper nose panel fold portion has an upper nose fold portion height, and when the respirator is in the closed mouth position, a fold height ratio between a) a combined interior height of the front panel fold portion height and the upper nose fold portion height and b) a combined exterior height of the mouth outer portion height and the nose panel free portion height, is in the range of about 0.4 to about 0.65.

3. The respirator of claim 1, wherein:
the mouth outer portion has a mouth outer portion surface area,
the nose panel free portion has a nose panel free portion surface area,
the front panel fold portion has a front panel fold portion surface area,
the upper nose panel fold portion has an upper nose fold portion surface area, and an interior fold surface area is formed by the front panel fold portion surface area and the upper nose fold portion surface area,
an exterior mask body surface area is formed by the mouth outer portion surface area and the nose panel free portion surface area, and
when the respirator is in the closed mouth position a fold surface area ratio between the interior fold surface area and the exterior mask body surface area is in the range of about 0.4 to about 0.65.

4. The respirator of claim 1, wherein the front mouth panel further comprises laterally spaced apart first and second rear edges, each rear edge having an upper portion, a lower portion, and a tab projecting rearwardly of the upper and lower portions.

5. The respirator of claim 4, further comprising a perimeter edge region around the mask body for contacting the skin of the user, the perimeter edge region having a facial attachment seal for sealingly connecting the respirator to the skin of the user, and wherein the tabs are located rearward of the facial attachment seal.

6. The respirator of claim 4, further comprising a first strap attached to the mask body above the tab of each rear edge and a second strap attached to the mask body below the tab of each rear edge.

7. The respirator of claim 1, wherein the front mouth panel comprises at least three layers including an interior layer with a higher stiffness than at least two other layers that increases the stiffness of the front mouth panel by greater than about 1000%.

8. The respirator of claim 7, wherein the front mouth panel comprises a mouth portion and a chin portion and the interior layer with higher stiffness is positioned exclusively in the mouth portion.

9. The respirator of claim 1, wherein the movable fold is a rounded fold.

10. The respirator of claim 9, wherein a location of the rounded fold moves when the mask body moves between the open mouth position and the closed mouth position.

11. The respirator of claim 10, wherein the facial attachment seal has a contour layer and an adhesive layer.

12. The respirator of claim 11, wherein the contour layer comprises at least one of an open cell foam and a closed cell foam.

13. The respirator of claim 1, wherein the front mouth panel and the upper nose panel are integrally formed.

14. A respirator for filtering respirated air by covering a nose area to a jaw area of a user, the respirator comprising:
a mask body having:
a front mouth panel having a front panel outer portion extending from an upper mouth panel edge to a lower chin edge and a front panel fold portion extending from the upper mouth panel edge, the front panel fold portion located behind the front panel outer portion; and
an upper nose panel having an upper nose panel fold portion and an upper nose panel free portion,
the upper nose panel fold portion extending from the front panel fold portion and underlying the front mouth panel, and the upper nose panel free portion extending upwardly from the upper nose panel fold portion to an upper mask edge, the upper nose panel free portion located above the front mouth panel,
a juncture of the upper nose panel fold portion and the front panel fold portion being a movable fold;
the movable fold being upwardly movable between a closed mouth position and an open mouth position,
wherein the lower chin edge is mechanically linked to the upper mouth panel edge by a support member such that movement of the lower chin edge causes movement of the upper mouth panel edge, and
wherein the upper mouth panel edge is mechanically decoupled from the upper mask edge by the movable fold such that the front mouth panel is independently movable from the upper nose panel.

15. The respirator of claim 14, wherein an edge spacing between the upper mask edge and the upper mouth panel edge being greater in the open mouth position than in the closed mouth position.

16. The respirator of claim 14, wherein the front panel fold portion and the upper nose panel fold portion are attached to the front mouth panel proximate a rear edge of the front mouth panel by a first end seam and a second end seam and each of the first end seam and the second end seam constrain the front panel fold portion and the upper nose panel fold portion from movement proximate the first end seam and the second end seam.

17. The respirator of claim 14, wherein the front mouth panel comprises a spine extending from proximate the upper mouth panel edge to proximate the lower chin edge and the spine is attached to at least a portion of the support member.

18. The respirator of claim 14, further comprising an edge forming a perimeter of the mask body, the perimeter having a facial attachment seal.

19. The respirator of claim 18, wherein the facial attachment seal has a contour layer and an adhesive layer.

20. The respirator of claim 19, wherein the contour layer comprises at least one of an open cell foam, a closed cell foam, and a hydrocolloid.

21. The respirator of claim 14, wherein the front mouth panel and the upper nose panel are integrally formed.

22. The respirator of claim 14, wherein the front mouth panel further comprises laterally spaced apart first and second rear edges, each rear edge having an upper portion, a lower portion, and a tab projecting rearwardly of the upper and lower portions.

23. The respirator of claim 22, further comprising a perimeter edge region around the mask body for contacting the skin of the user, the perimeter edge region having a facial attachment seal for sealingly connecting the respirator to the skin of the user, and wherein the tabs are located rearward of the facial attachment seal.
